(19) United States
(12) Patent Application Publication
(10) Pub. No.: US 2024/0239040 A1
(43) Pub. Date: Jul. 18, 2024

(54) Laser Marking System and Method

(71) Applicant: SILICON LIGHT MACHINES CORPORATION, San Jose, CA (US)

(72) Inventors: Gregory Jacob, Santa Clara, CA (US); Stephen Hamann, Mountain View, CA (US); Alexander Payne, Ben Lommond, CA (US); Lars Eng, Los Altos, CA (US); James Hunter, Campbell, CA (US); Tianbo Liu, San Jose, CA (US); Hirofumi Mizuno, San Jose, CA (US)

(73) Assignee: SILICON LIGHT MACHINES CORPORATION, San Jose, CA (US)

(21) Appl. No.: 18/416,708

(22) Filed: Jan. 18, 2024

Related U.S. Application Data
(63) Continuation-in-part of application No. 17/591,884, filed on Feb. 3, 2022.
(60) Provisional application No. 63/439,765, filed on Jan. 18, 2023.
(60) Provisional application No. 63/183,789, filed on May 4, 2021.
(60) Provisional application No. 63/146,488, filed on Feb. 5, 2021.

(51) Int. Cl. B29C 64/135; B29C 64/273; B33Y 10/00; B33Y 30/00; B41J 2/44; B41J 2/47; B41M 3/00; B41M 5/00; B41M 5/26; G02B 26/08; G02B 26/10

(52) U.S. Cl. CPC B29C 64/135; B29C 64/273; B33Y 10/00; B33Y 30/00; B41J 2/442; B41J 2/471; B41M 3/008; B41M 5/0058; B41M 5/0064; B41M 5/262; B41M 5/267; G02B 26/0808; G02B 26/10

(57) ABSTRACT

A laser manufacturing system including a spatial light modulator (SLM) with a rectangular array of electrically actuated two-dimensional (2D) diffractors arranged to form multiple pixels spaced linearly along a long-axis thereof, each pixel including a plurality of 2D diffractors electrically ganged together and arranged along a short-axis perpendicular to the long-axis. The system further includes a laser and optics to illuminate the SLM, and projection optics to project modulated light from the SLM onto a surface of a workpiece to form an anamorphic image of the SLM that is demagnified along the long-axis of the SLM and tightly focused along the short-axis to form a condensed line beam to mark the workpiece. The line beam has a sinc² profile along the short-axis and a top-hat along the long-axis. Demagnification and the resulting long-axis length at the workpiece is chosen based on the pulse-energy of the laser and targeted peak fluence.

### CROSS-REFERENCE TO RELATED APPLICATIONS

This application is a continuation-in-part of U.S. patent application Ser. No. 17/591,884, filed Feb. 3, 2022, which claims the benefit of priority under 35 U.S.C. 119(e) to U.S. Provisional Patent Application Ser. No. 63/146,488, filed Feb. 5, 2021, and to U.S. Provisional Patent Application Ser. No. 63/183,789, filed May 4, 2021, all of which are incorporated by reference herein in its entirety. This application further claims the benefit of priority under 35 U.S.C. 119(e) to U.S. Provisional Patent Application Ser. No. 63/439,765, filed Jan. 18, 2023.

### TECHNICAL FIELD

The present invention relates generally to laser marking systems, and more particularly to laser marking systems including spatial light modulators with a multi-pixel, linear array of is a microelectromechanical systems based diffractors, and methods of operating the same.

### BACKGROUND

Laser marking systems are used in a wide range of industries to create an image or mark, such as text, logos, barcodes, or two-dimensional, QR codes on a surface of parts or articles. Common methods of marking include oxidizing, annealing, etching or ablating or discoloring the surface. Advantages of laser marking include that it can be performed on a wide variety of materials, it is permanent, and does not require physical contact to mark a surface of a workpiece.

Laser marking systems typically use a single laser beam that is scanned across the surface of the workpiece using galvanometric mirrors and print one spot at a time. Thus, depending on the size and complexity or density of pixels in the mark or image, current laser marking systems can have marking times of two minutes or more to mark the surface of a single workpiece. Additionally, attempts have been made to print or mark to larger areas using laser marking systems including spatial light modulators (SLM), such as digital micro-mirror devices (DMDs), commercially available from Texas Instruments, and liquid crystal on silicon (LCOS) modulators. However, these existing SLMs cannot handle the high power lasers needed to mark larger areas than a single spot at a time.

Typical single-spot laser marking systems use beam diameters around 60 μm with scan rates in excess of 1000 mm/s³. While high power, ultrafast laser sources have become more cost effective in recent years, laser power of these systems must be restricted to avoid damaging the substrate. Additionally, while focusing lenses can be added or changed if finer resolution is required, this results in lower scan rates and comes with a penalty to throughput.

Accordingly, there is a need for a laser marking system capable of marking a larger area than a single spot at a time to decrease marking time and increase system throughput. Additionally, there is a further need for a laser marking system capable of using higher power lasers to both decrease marking time and increase an area that can be marked at a single time.

### SUMMARY

A laser manufacturing system including a spatial light modulator (SLM) with a rectangular array of electrically actuated two-dimensional (2D) diffractors arranged to form multiple pixels spaced linearly along a long-axis thereof, each pixel including a plurality of 2D diffractors electrically ganged together and arranged along a short-axis perpendicular to the long-axis. The system further includes illumination optics and a laser to illuminate the SLM, and projection optics operable to project modulated light from the SLM onto a surface of a workpiece to form an anamorphic reflection or image of the SLM that is demagnified along the long-axis of the SLM and tightly focused along the short-axis to form a condensed line beam to mark the surface of the workpiece. The line beam has a sinc² profile along the short-axis and a top-hat along the long-axis. The demagnification and resulting long-axis length at the workpiece is chosen based on the pulse energy of the laser and targeted peak fluence.

Further features and advantages of embodiments of the invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to a person skilled in the relevant art(s) based on the teachings contained herein.

### BRIEF DESCRIPTION OF THE DRAWINGS

Embodiments of the invention will now be described, by way of example only, with reference to the accompanying schematic drawings in which corresponding reference symbols indicate corresponding parts. Further, the accompanying drawings, which are incorporated herein and form part of the specification, illustrate embodiments of the present invention, and, together with the description, further serve to explain the principles of the invention and to enable a person skilled in the relevant art(s) to make and use the invention.

FIG. 1 is a block diagram of a laser marking system including a spatial light modulator (SLM);

FIGS. 2A-2C are schematic block diagrams illustrating an embodiment of a SLM including ribbon-type Microelectromechanical System (MEMS) based diffractors;

FIGS. 3A-3C are schematic block diagrams illustrating an embodiment of a SLM including MEMS based two-dimensional (2D) diffractors;

FIG. 4 is a schematic block diagram of a top view of an SLM including a multi-pixel, linear array of MEMS based 2D diffractors, such as those shown in FIGS. 3A-3C;

FIGS. 5A and 5B are schematic block diagrams of an embodiment of a laser marking system including an SLM with a multi-pixel, linear array of MEMS based diffractors, and galvanometric mirrors for scanning;

FIGS. 6A-6C are schematic block illustrating single-stripe and multi-stripe scanning using a laser marking system including an SLM with a multi-pixel, linear array of MEMS based diffractors for surface modification;

FIG. 7 is an optics diagram illustrating illumination and imaging light paths along a vertical or longitudinal axis of a linear array for a laser marking system including an SLM with a multi-pixel, linear array of MEMS based diffractors for surface modification;

FIG. 8 is a schematic block diagram of an embodiment of a laser marking system including an SLM with a multi-pixel, linear array of MEMS based diffractors, and a moving fixture or stage to which a workpiece can be affixed;

FIG. 9 is a schematic block diagram of another embodiment of a laser marking system including an SLM with a multi-pixel, linear array of MEMS based diffractors, and with focus before the galvanometric mirrors for scanning;

FIG. 10 is a flowchart of a method of modifying or marking a surface using a surface modification system including a MEMS based SLM;

FIGS. 11A through 11C are schematic block illustrating a method of modifying or marking a surface using interleaving of two or more scans of the surface;

FIGS. 12A and 12B are schematic block diagrams two adjacent groups of eight pixels in a linear array of MEMS based 2D diffractors illustrating a pixel shaping method for recording an image with a high density pattern;

FIG. 13 is a schematic block diagram of a top view of the optical areas of a two-dimensional (2D) planar light valve (PLV™) including a multi-pixel, linear array of MEMS based 2D diffractors or pistons, such as those shown in FIGS. 3A-3C;

FIG. 14A is a schematic block diagram of a top view of a portion of a high-throughput multi-beam laser manufacturing system including a 2D PLV™ type SLM;

FIG. 14B is a schematic illustration of top-hat illumination on the 2D PLV™ of FIG. 14A;

FIG. 14C is a schematic illustration of a condensed line beam of modulated light produced by the 2D PLV™ and projected onto a surface of a workpiece;

FIG. 15A is an optical schematic of a laser manufacturing or marking system along a short axis of the PLV™;

FIG. 15B is an optical schematic of the system of FIG. 15A along a long axis of the PLV™;

FIG. 16 is a schematic illustration of a line beam profile at the workpiece having a top-hat profile along a long-axis with contiguous segments in which the intensity is controlled by a pixel of the PLV™, and a short-axis has a sinc² profile;

FIG. 17 is a schematic block diagram of a calibration system used to view a modulated line beam at a work surface to calibrate a laser marking system;

FIG. 18 is a two-dimensional (2D) image illustrating a method for using the laser marking system to form images larger than a line beam of modulated light at a workpiece surface using a serpentine scan path;

FIG. 19 shows a series of images further illustrating a method for using the laser marking system to form images larger than a line beam using a serpentine scan path;

FIGS. 20A-20E are schematic block diagrams of embodiments of a laser marking system including galvanometric mirrors or movable x-y stages for creating 2D images;

FIG. 21 is a schematic block illustrating communications to synchronize a PLV™ pattern with stage motion to create 2D images;

FIGS. 22A and 22B are schematic block diagrams illustrating the effect of a grid size of successive scans used to create an image on image resolution;

FIGS. 23A through 22C are images illustrating the effect of a grid size of successive scans used to create the image on image resolution;

FIGS. 24A through 24C are images illustrating a sine-wave stitching technique that can be used for large solid marked areas to minimize or eliminate vertical banding between adjacent swaths;

FIG. 25 is a flowchart of a method of modifying or marking a surface using a high-throughput multi-beam laser manufacturing system including a MEMS based SLM; and

FIG. 26 is a block diagram illustrating an additive manufacturing system including a high-throughput multi-beam laser manufacturing system including a 2D PLV™ type SLM.

### DETAILED DESCRIPTION

A laser marking system including a spatial light modulator (SLM) with a multi-pixel, linear array of microelectromechanical systems (MEMS) based diffractors, and methods of operating the same are described herein with reference to figures.

In the following description, for purposes of explanation, numerous specific details are set forth in order to provide a thorough understanding of the present invention. It will be evident, however, to one skilled in the art that the present invention can be practiced without these specific details. In other instances, well-known structures, and techniques are not shown in detail or are shown in block diagram form in order to avoid unnecessarily obscuring an understanding of this description.

Reference in the description to “one embodiment” or “an embodiment” means that a particular feature, structure, or characteristic described in connection with the embodiment is included in at least one embodiment of the invention. The appearances of the phrase “in one embodiment” in various places in the specification do not necessarily all refer to the same embodiment. The term to couple as used herein can include both to directly electrically connect two or more components or elements and to indirectly connect through one or more intervening components.

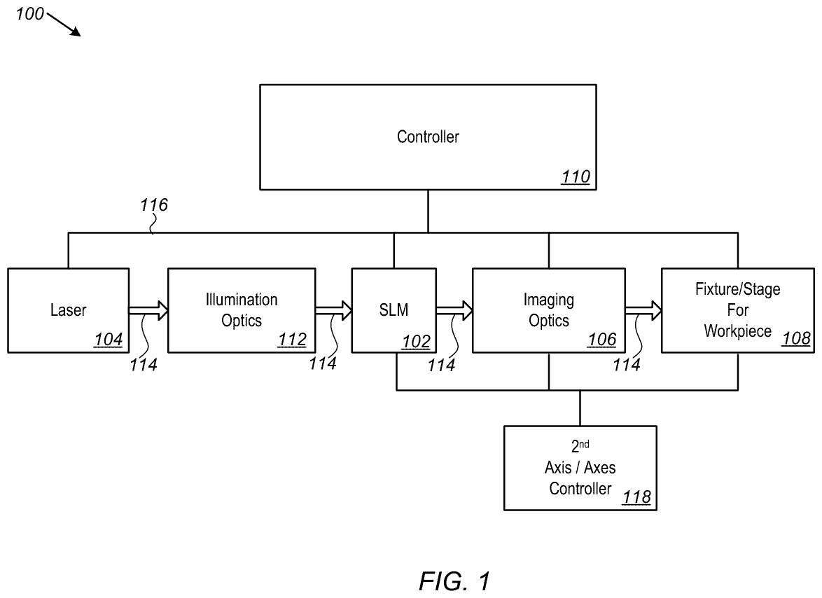

FIG. 1 is a block diagram of a laser marking system 100 including a spatial light modulator (SLM 102) with a multi-pixel, linear array of Microelectromechanical System (MEMS) based diffractors (not shown in this figure). Briefly, the laser marking system 100 includes, in addition to the SLM 102, a laser 104 operable to illuminate the SLM, imaging optics 106 operable to focus a substantially linear swath of modulated light onto a surface of a workpiece on fixture 108 or stage, and a controller 110 operable to control the SLM, laser and imaging optics to scan the linear swath of modulated light across the surface of the workpiece to record a two-dimensional (2D) image thereon. Generally, as in the embodiment shown, the laser marking system 100 further includes illumination optics 112 with a beam forming optical system to direct a rectangular beam onto the linear array of the SLM 102.

Typically, the laser 104 is capable of operating in ultraviolet (UV) wavelengths of from 355 nanometers (nm) through infrared (IR) wavelengths up to about 2000 nm in either a continuous wave (CW) mode, or in a pulse mode with widths or durations of from about 1 femtoseconds (fs) up to about 500 nanoseconds (ns) at a repetition rate of from about 10 kHz up to about 300 kHz, and at energy ranges of from about 10 microjoules (μJ) up to greater than 10 millijoules (mJ). In one embodiment particularly useful for laser marking systems the laser 104 is capable of operating in visible wavelength (Δ) of about 514 nm, at pulse energies of from about 200 μJ at a pulse width or duration of about 260 fs and repetition rate of 100 kHz.

As noted above, the SLM 102 includes a multi-pixel; linear array of MEMS based diffractors grouped or coupled to provide from about 10 to about 1088 individually addressable pixels. Suitable SLM 102 include those having a linear array of ribbon-type, electrostatically adjustable diffraction grating, such as a Grating Light Valve (GLV™), and MEMS based two-dimensional (2D) diffractors, such as a Linear Planar Light Valve (LPLV™), both of which are commercially available from Silicon Light Machines Inc., of San Jose CA, and are described in detail hereinafter.

The imaging optics 106 can include dynamic optical elements, such as galvanometric mirrors, to scan the linear swath of modulated light across the surface of the workpiece, and a number of static optical elements to direct modulated light to the galvanometric mirrors and/or to focus the modulated light from the galvanometric mirrors onto the surface of the workpiece.

The fixture 108 on which the workpiece to be marked is placed or affixed can include a static fixture, or a movable stage operable to move or reposition the workpiece relative to a substantially stationary linear swath of modulated light, to scan the linear swath of modulated light across the surface of the workpiece. In either embodiment, whether static or movable, the fixture 108 preferably includes a number of sensors and signaling means to signal other components in the laser marking system when the workpiece is in proper position to be marked. In some embodiments, described in greater detail hereinafter, the fixture 108 includes a movable stage capable of being moved along two orthogonal axes to enable scanning multiple parallel swaths to record or mark larger 2D images on the workpiece. In other embodiments, laser marking system 100 includes both imaging optics 106 with galvanometric mirrors, and a movable stage (fixture 108) capable of being moved along a single axis orthogonal to the direction the galvanometric mirrors scan the linear swath of modulated light to record or mark larger 2D images on the workpiece.

The laser 104, illumination optics 112, SLM 102, imaging optics 106 and workpiece held on the fixture 108 are optically coupled in the direction indicated by arrows 114. Additionally, the laser 104, illumination optics 112, SLM 102, imaging optics 106 and fixture 108 are electrically coupled in signal communication with the controller 110 and each other through a control bus 116. In particular, controller 110 provides digital image data to the SLM 102, controls a power level of the laser 104, controls operation of galvanometric mirrors in the imaging optics 106 and controls the movable stage of the fixture 108 (where included) through the control bus 116. Additionally, the fixture 108 can signal the controller 110, SLM 102 and/or the laser 104 when the workpiece is in proper position to be marked, and the SLM can signal the laser when the image data loaded to the SLM is ready to be recorded on the workpiece so that the laser can be pulsed.

Optionally, as in the embodiment shown, the laser marking system 100 can further include a second axis or axes controller 118 electrically coupled in signal communication with the SLM 102, imaging optics 106 and movable stage of the fixture 108 (where included) through a second control bus 116 control movement of the linear swath along one of two orthogonal axes.

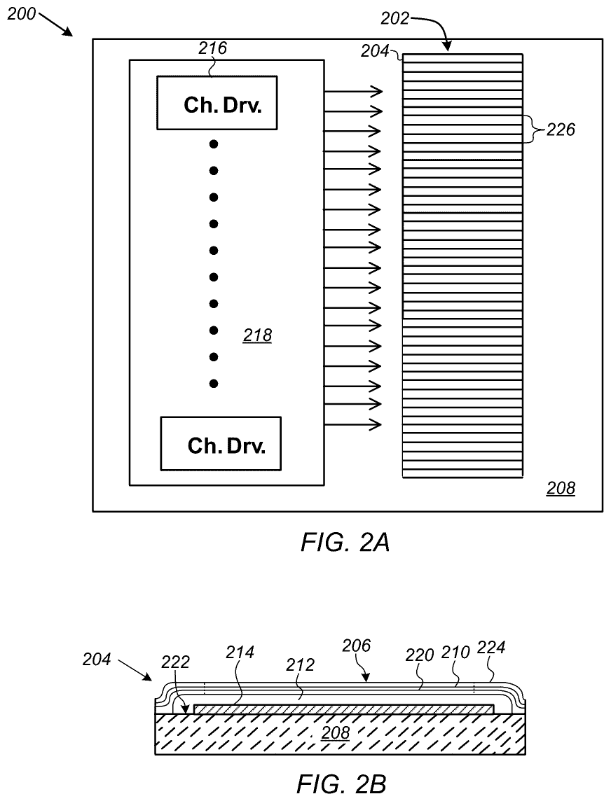

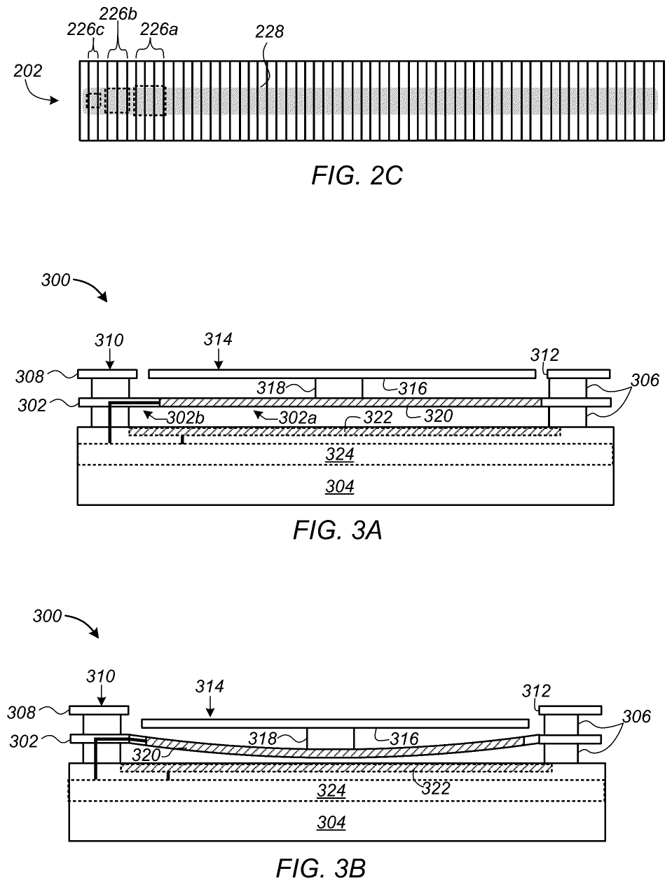

An embodiment of a SLM including a multi-pixel, linear array of MEMS based ribbon-type, electrostatically adjustable diffractors, such as a GLV™ will now be described with reference to FIGS. 2A through 2C. For purposes of clarity, many of the details of SLMs in general and MEMS based ribbon-type diffractors in particular that are not relevant to the present invention have been omitted from the following description. The drawings described are only schematic and are non-limiting. In the drawings, the size of some of the elements may be exaggerated and not drawn to scale for illustrative purposes. The dimensions and the relative dimensions may not correspond to actual reductions to practice of the invention.

Referring to FIGS. 2A and 2B in the embodiment shown the SLM 200 includes a linear array 202 composed of thousands of free-standing, addressable electrostatically actuated ribbons 204, each ribbon having a light reflective surface 206 supported over a surface of a substrate 208, where a number of ribbons are grouped together to form the MEMS based diffractors. Each of the ribbons 204 includes an electrode 210 and is deflectable through a gap or cavity 212 toward the substrate 208 by electrostatic forces generated when a voltage is applied between the electrode 210 in the ribbon 204 and a base electrode 214 formed in or on the substrate. Each of the electrodes 210 are driven by one of a number of drive channels 216 in a driver 218, which may be integrally formed on the same substrate 208 with the linear array 202, as in the embodiment shown, or formed on a second substrate or chip and electrically coupled thereto (not shown).

A schematic sectional side view of a ribbon 204 of the SLM 200 of FIG. 2A is shown in FIG. 2B. Referring to FIG. 1B, the ribbon 204 includes an elastic mechanical layer 220 to support the ribbon above a surface 222 of the substrate 208, a conducting layer or electrode 210 and a reflective layer 224 including the reflective surface 206 overlying the mechanical layer and conducting layer.

Generally, the mechanical layer 220 comprises a taut silicon-nitride film, and is flexibly supported above the surface 222 of the substrate 208 by a number of posts or structures, typically also made of silicon-nitride, at both ends of the ribbon 204. The conducting layer or electrode 210 can be formed over and in direct physical contact with the mechanical layer 220, as shown, or underneath the mechanical layer. The conducting layer or electrode 210 can include any suitable conducting or semiconducting material compatible with standard MEMS fabrication technologies. For example, the conducting layer used for the electrode 210 can include a doped polycrystalline silicon (poly) layer, or a metal layer. Alternatively, if the reflective layer 224 is metallic it may also serve as the electrode 210.

The separate, discrete reflecting layer 224, where included, can include any suitable metallic, dielectric or semiconducting material compatible with standard MEMS fabrication technologies, and capable of being patterned using standard lithographic techniques to form the reflective surface 206.

In the embodiment shown, a number of ribbons are grouped together to form a large number of MEMS channels or pixels 226, each driven by a much smaller number of drive channels 216. Deflection of a ribbon 204 causes light reflected from the reflective surface 206 to constructively or destructively interfere with light reflected from the reflective surface of an adjacent ribbon, there enabling the pixel 226 to switch between an on or bright state, an off or dark state or an intermediate gray-scale. In particular, it is noted that gray-scale control of the MEMS based diffractors can provide a precise dosage of light from each pixel onto the surface of the workpiece to compensate for non-uniformities in light illuminating the SLM 200 or in modulated transmitted from the SLM to a surface of a workpiece through imaging optics.

Referring to FIG. 2C in one embodiment suitable for laser marking systems, the linear array 202 includes 1088 individually addressable ribbons 204 that can be grouped together to form channels or pixels 226 having any number of ribbons depending on pixel size requirements. Additionally, the SLM can include drive channels 216 (shown in FIG. 2A) with up to 10-bit amplitude modulation to support gray-scale, and is capable of being modulated or switched at speeds up to 350 kHz. Referring again to FIG. 2C, shaded rectangle illustrates an illuminated area 228 on the linear array 202 illuminated by a rectangular beam directed onto the SLM 200. In some embodiments for laser marking systems, it is desirable to provide pixel configurations having a square aspect ratio. For example, in the embodiment shown wherein the linear array 202 includes about ribbons 204, each having a width of about 25 μm, and the illuminated area 228 has a width of about 75 μm, the ribbons can be grouped to form 360 square pixels 226a each including portions of three adjacent ribbons. Alternatively, the width of the illuminated area can be reduced to about 50 μm and the ribbons 204 can be grouped to form 512 50 μm×50 μm square pixels 226b each including portions of two adjacent ribbons, or the width of the illuminated area can be further reduced to about 25 μm such that each ribbon forms 1088 25 μm×25 μm square pixels 226c.

Advantages of the ribbon-type MEMS based SLM 200 include:
a. Linear array 202 pixel counts from about 1000 to about 8000 pixels 226;
b. Ability to modulate a wide range of laser wavelengths from 355 to 1064 nm, including about 514 nm;
c. Low mass and high tension of the ribbons 204 enable high speed switching of less than about 300 ns—up to ten times faster digital micro-mirror devices (DMDs) and a thousand times faster than liquid crystal on silicon (LCOS) devices;
d. Natural Analog gray-scale control of modulated light intensity, with amplitude resolution limited only by bit-depth of drive channels 216;
e. High power handling due to the ribbons 204 being made of silicon nitride, a robust, amorphous, high-temperature ceramic, with power densities up to and exceeding 10 kW/cm²;
f. Non-contact, high reliability >10,000-hour lifetime demonstrated even under high-fluence UV illumination;
g. Borderless pixels with images being formed by spatially filtering the angularly modulated light, eliminating “screen door” effect of projected pixel images.

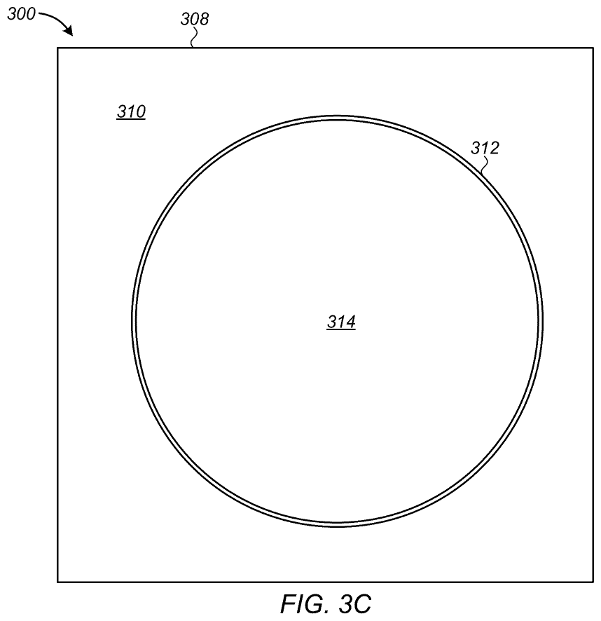

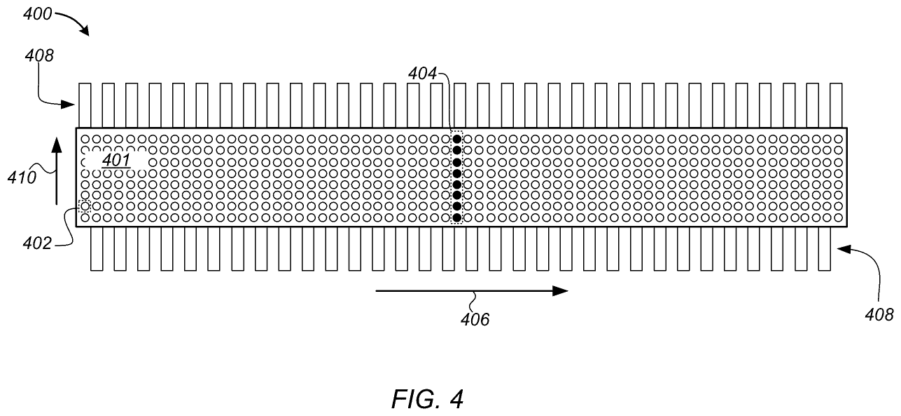

Another type of SLM including a multi-pixel, linear array of MEMS based two-dimensional (2D) diffractors, such as a Linear Planar Light Valve (LPLV™) commercially available from Silicon Light Machines, Inc., of San Jose, California, which is particularly advantageous for use in laser marking will now be described with reference to FIGS. 3A through 3C and FIG. 4.

For purposes of clarity, many of the details of fabricating and operating MEMS based two-dimensional (2D) diffractors, which are widely known and not relevant to the present invention, have been omitted from the following description. MEMS based 2D diffractors are described in greater detail, for example, in commonly assigned U.S. Pat. No. 7,064,883, entitled, “Two-Dimensional Spatial Light Modulator,” by Alexander Payne et al., issued on Jun. 20, 2006, and incorporated herein by reference in its entirety.

FIG. 3A illustrates a schematic block diagram of a sectional side view of a 2D modulator or diffractor 300 in a quiescent or un-driven state. Referring to FIG. 3A, the 2D diffractor 300 generally includes a piston layer 302 suspended over a surface of a substrate 304 by posts 306 at corners of the piston layer and/or 2D diffractor. The piston layer 302 includes an electrostatically deflectable piston 302a and a number of flexures 302b through which the piston is flexibly or movably coupled to the posts 306. A faceplate 308 overlying the piston layer 302 includes a first light reflective surface 310 and an aperture or cut-out portion 312 which separates the faceplate from a second reflective surface 314 on or attached to the piston 302a. The second light reflective surface 314 can either be formed directly on the top surface of the piston 302a, or, as in the embodiment shown, on a mirror 316 supported above and separated from the piston 302a by a central post 318 extending from the piston to the mirror. The first and second light reflective surfaces 310, 314, have equal area and reflectivity so that in operation electrostatic deflection of the piston 302a caused by an electrode 320 formed in or on the piston layer 302 and an electrode 322 in the substrate 304 brings light reflected from the first light reflective surface 310 into constructive or destructive interference with light reflected from the second light reflective surface 314.

Generally, the electrode 322 in the substrate 304 is coupled to one of a number drive channels in a drive circuit or driver 324, which can be integrally formed in the substrate adjacent to or underlying the 2D diffractor 300, as in the embodiment shown. The electrode 322 in the substrate 304 can be coupled to the driver 324 through a via extending through the substrate from the driver to the electrode, and the electrode 320 formed in or on the piston layer 302 can be coupled to the driver or an electrical ground through a conductor extending through one of the posts 306 and the piston layer. As explained in greater detail below, typically multiple individual 2D diffractors 300 are grouped or ganged together under control of a single drive channel to function as a single pixel in the multi-pixel, linear array of the SLM.

FIG. 3B is a schematic block diagram of the 2D diffractor 300 of FIG. 3A in an active or driven state, showing the piston 302a deflected towards the substrate 304, and FIG. 3C is a top view of the 2D diffractor of FIGS. 3A and 3B illustrating the static first light reflective surface 310 and the movable second light reflective surface 314.

An exemplary multi-pixel, linear array of dense-packed, MEMS based 2D diffractors will now be described with reference to the block diagram of FIG. 4. FIG. 4 is a planar top view of a SLM 400 including a linear array 401 of 2D diffractors 402, such as those shown in FIGS. 3A-C, grouped or coupled together to a number of drive channels to or pixels.

Referring to FIG. 4, in one embodiment the 2D diffractors 402 are grouped into a linear array 401 of interleaved channels or pixels 404 along a first, horizontal or longitudinal axis 406. Each of the 2D diffractors 402 in a single pixel 404 share a common drive channel or driver 408. Although in the embodiment shown each pixel 404 is depicted as having a single column of 12 2D diffractors 402 grouped along a transverse or vertical or transverse axis 410 perpendicular to the horizontal or longitudinal axis 406 of the array, this is merely to facilitate illustration of the array. It will be appreciated that each channel or pixel can include any number of 2D diffractors arranged in one or more columns of any length across the width or vertical or transverse axis of the array without departing from the spirit and scope of the invention. For example, in one embodiment of the SLM 400 particularly suited for the spectral shaping systems and methods of the present disclosure, each pixel 404 includes a single column of 40 diffractors grouped along the transverse axis 410 of the array. Similarly, the SLM 400 can include an array 401 of any number of pixels 404 or a number of individual arrays 401 placed end to end adjacent to one another. This later configuration can help to increase power handling of the SLM 400 as the optically active area of the array 401 gets larger by increasing the number of columns of diffractors per pixel. If the damage threshold per diffractor is constant, power handling can be increased proportional to the area increase.

In order to maximize or provide sufficient contrast for the SLM 400 it is desirable that incident light from an illumination source, have a numerical aperture (NA) or cone angle (Θ)) which is smaller than the first-order diffraction angle (θ) of the diffractive SLM 400. The diffraction angle (θ) of the SLM is defined as the angle between light reflected from a pixel 404 in the 0^{th} order mode or state, and light reflected from the same pixel in the plus and/or minus 1^{st} order mode. However, according to the grating equation, diffraction angles of a periodic surface, such as the array 401 of the SLM 400, are set by a ratio of wavelength of light incident on the array to a spatial period or pitch of features of the periodic surface, i.e., the pixels 404. In particular, the grating equation states:

$$sin θ = m λ / Λ$$

where θ is a diffraction angle of light reflected from the surface, m is order of diffracted ray (integer), λ is the wavelength of the incident light, and Λ is a spatial or pitch of the diffractor 402. When we focus on a single pixel which has multiple 2D diffractors 402 and the incident light is ideal plane wave or has a numeric aperture (NA)=0, the light spreads due to Huygen-Fresnel principle. The spreading angle Θ is defined:

$$Θ = λ / D$$

where D is a pixel size.

Achieving adequate contrast with conventional grating based SLMs requires either limiting illumination NA by means of an aperture (and suffering the associated throughput loss), or providing a large diffraction angle by reducing the size and spatial period or pitch of the individual diffractors. However, this latter approach is problematic for a number of reasons including the need for larger, higher voltage drive circuits to drive smaller, movable grating elements, and a reduction of an optical power handling capability of the SLM resulting from such smaller grating elements.

In contrast to conventional grating based SLMs, a SLM 400 including MEMS-based, 2D diffractors 402, such as the LPLV™ is configured to have multiple pixels 404 each pixel including several 2D diffractors 402 arranged along the transverse or vertical axis 410 of the array (twelve in the embodiment shown), but with a much smaller number, generally only one or two diffractors, arranged along the horizontal or longitudinal axis 406. Because of this, the spreading angle Θ_{H} of diffracted light from the pixel 404 along the longitudinal axis, where the pixel size is much smaller than along the vertical or transverse axis, is much larger than the spreading angle Θ_{V} of the pixel along the transverse axis. Conversely, the numerical aperture of illumination in the vertical direction (array short axis) can be much larger than the numerical aperture in the horizontal direction (array long axis) since the latter is limited by the diffraction angle of the SLM in order to achieve sufficient contrast. Thus by using a linear array of 2D diffractors in combination with an asymmetric illumination NA in the longitudinal and transverse directions, the overall throughput of the spectral shaper can be improved.

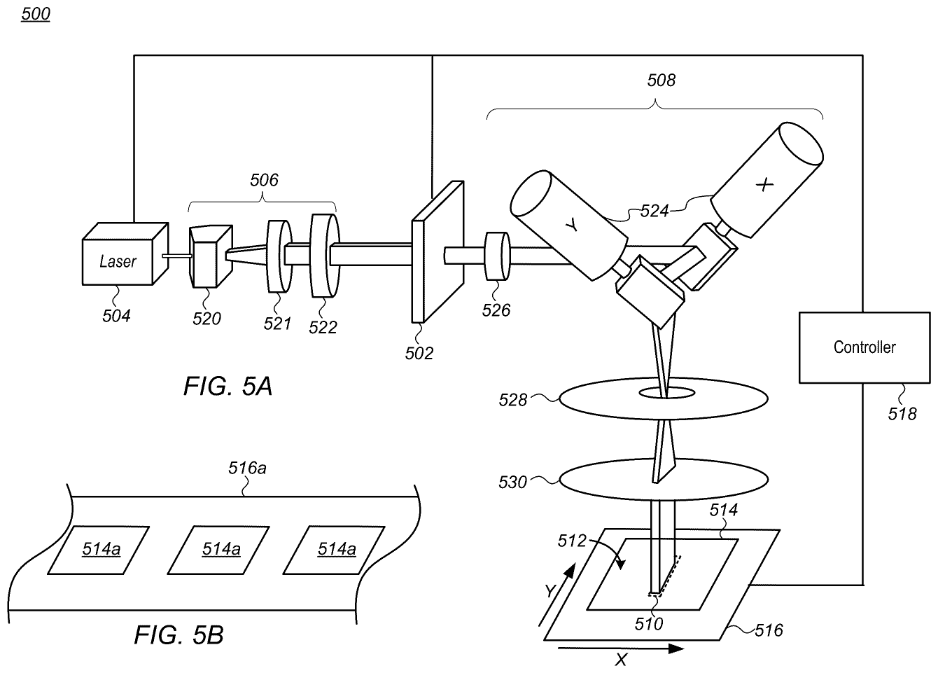

FIG. 5A is a schematic block diagram of an embodiment of a laser marking system 500 including an SLM 502 with a multi-pixel, linear array of MEMS based diffractors, and galvanometric mirrors for scanning. For purposes of clarity and to simplify the drawings the optical light path is shown as being unfolded causing the SLM 502 to appear as transmissive. However, it will be understood that because the SLM 502 is reflective the actual light path is folded to an angle of 90° or less at the SLM.

Referring to FIG. 5A, the laser marking system 500 includes, in addition to the SLM 502, a laser 504 operable to generate laser light used to illuminate the SLM, illumination optics 506 to direct laser light onto the SLM, imaging optics 508 operable to focus a substantially linear swath of modulated light 510 onto a surface 512 of a workpiece 514 on or affixed to a fixture 516 or stage, and a controller 518 operable to control the SLM, laser and imaging optics to scan the linear swath of modulated light across the surface of the workpiece to record a 2D image thereon.

As noted above, the laser 504 is capable of operating in UV wavelengths of from 355 nm through IR wavelengths up to about 2000 nm in either CW mode, or in a pulse mode with widths or durations of from about 1 fs up to about 500 ns at a repetition rate of from about 10 kHz up to about 300 kHz, and at energy ranges of from about 10 microjoules (μJ) up to greater than 10 millijoules (mJ).

The SLM 502 can include a multi-pixel; linear array of MEMS based, ribbon-type diffractors, such as shown in FIGS. 2A through 2C, or a multi-pixel, linear array of 2D diffractors, such as shown in FIGS. 3A through 3C and FIG. 4.

The illumination optics 506 can include a beam forming optical system to direct laser light onto the SLM 502. Referring to FIG. 5A, elements of the beam forming optical system can include a Powell lens 520, a long axis collimating lens 521, and a cylindrical, short axis focusing lens 522 to shape or focus the illumination into a rectangular beam or line of illumination extending substantially uniformly across the linear array of the SLM 502.

The imaging optics 508 can include galvanometric mirrors 524 to scan the linear swath of modulated light 510 across the surface 512 of the workpiece 514, a number of cylindrical lens 526 to direct modulated light to the galvanometric mirrors, and a Fourier aperture 528 to separate a 0^{th} order beam in the modulated light from 1^{st} order beams, and a Fourier Transform (FT) lens 530 to focus the modulated light onto the surface of the workpiece.

Preferably, the cylindrical lens 526 and FT lens 530 of the imaging optics include fused silica lenses to reduce thermal focus shift of the modulated light focused onto the surface 512 of a workpiece 514. In some embodiments, one or more of the lenses 520, 521, 522 of the illumination optics 506 can also include fused silica lenses to reduce thermal focus shift of the laser light focused onto the SLM 502.

The fixture 516 on which the workpiece 514 to be marked is placed or affixed can include a static fixture, or a movable stage operable to move or reposition the workpiece relative to a substantially stationary linear swath of modulated light, to scan the linear swath of modulated light across the surface of the workpiece. As noted above, in either embodiment, whether static or movable, the fixture 516 preferably includes a number of sensors and signaling means to signal other components in the laser marking system when the workpiece is in proper position to be marked.

In an alternative embodiment shown in FIG. 5B, the fixture 516 includes a movable belt 516a operable to move a number of individual parts or workpieces 514a past a focus of the 500 quickly and efficiently mark or record an image or images on a number of parts or workpieces. It will be understood that because a speed at which data can be loaded to the controller 518 for the SLM 502 is independent of and much greater than a speed at which the fixture 516 or belt 516a is moved and the image recorded, the laser system 500 can customize the image recorded on each individual part or workpiece 514/514a. Such images can include, for example, a serial number, part number, and data or a data sheet for the part.

Depending on the size of the linear swath of modulated light 510 and/or an image to be recorded it can be recorded on the surface 512 of a workpiece 514 in a single scan or single-stripe of the linear swath of modulated light 510 across the surface along a single axis, or by multiple scans or stripes (multi-stripes) of the linear swath of modulated light across the surface along a first axis perpendicular to a long axis of the linear swath of modulated light, followed by repositioning the linear swath of modulated light along a second axis parallel to the long axis of the linear swath.

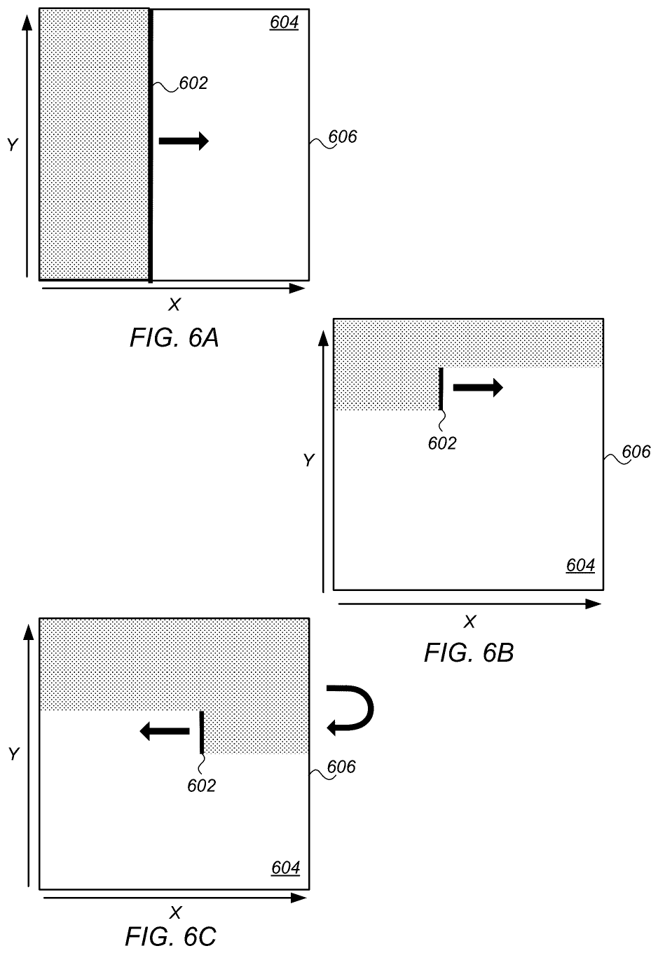

FIGS. 6A-6C are schematic block illustrating single-stripe and multi-stripe scanning using a laser marking system, such as that shown in FIGS. 5A and 5B.

FIG. 6A illustrates an embodiment of single-stripe scanning in which a linear swath of modulated light 602 is moved across a surface 604 of the workpiece 606 once in a single direction to record an image in a single pass or scan. It will be understood that this embodiment provides the shortest write-time, in some embodiments less than 1 second, and can reduce the complexity of the laser marking system by requiring only a single axis scanner in the X-direction. It is noted however that a laser marking systems using single-stripe scanning may require a higher energy laser of 1 millijoule or more, depending on a physical size of the pixels in the linear array of the SLM relative to the linear swath of modulated light 602 may have lower resolution and contrast than a multi-stripe system using a smaller or shorter linear swath of modulated light 602 and stitching together multiple scans or passes to form an image.

FIG. 6B illustrates an embodiment of multi-stripe scanning in which the linear swath of modulated light 602 is moved across the surface 604 of the workpiece 606 multiple times in the X-direction followed by indexing or repositioning the linear swath of modulated light in a Y-direction and repeating the scan in the same X-direction to record an image using multiple scans or passes stitched together. By stitched together it can mean either that the second and subsequent scans overlap the prior scan or that scans abut or adjoin one another on the surface 604 of the workpiece 606 substantially without overlapping. It will be understood that while this multi-stripe method has longer write-times than the single-stripe approach it is still significantly faster than the point-by-point method of prior laser marking systems using DMD or LCOS modulators. It will be further understood that the shorter long axis of the linear swath of modulated light 602 on enables the use of lower power lasers, while providing greater resolution and contrast in the recorded image.

FIG. 6C illustrates another embodiment of multi-stripe scanning in which the linear swath of modulated light 602 is not reset to an initial starting point on the X-axis prior to starting a second or subsequent scan, but rather reverses direction of the scan in the X-direction after indexing or repositioning the linear swath of modulated light in the Y-direction. It will be understood that this embodiment provides a shorter write-time than that of FIG. 6B by eliminating the need reposition an X-axis galvanometric mirror or a movable stage or fixture following completion of each scan in the X-direction, while proving the same improvement in resolution and contrast and enabling use of a lower power laser. As in the embodiment described with respect to FIG. 6B the multiple scans or passes can be stitched together in either overlapping or non-overlapping passes.

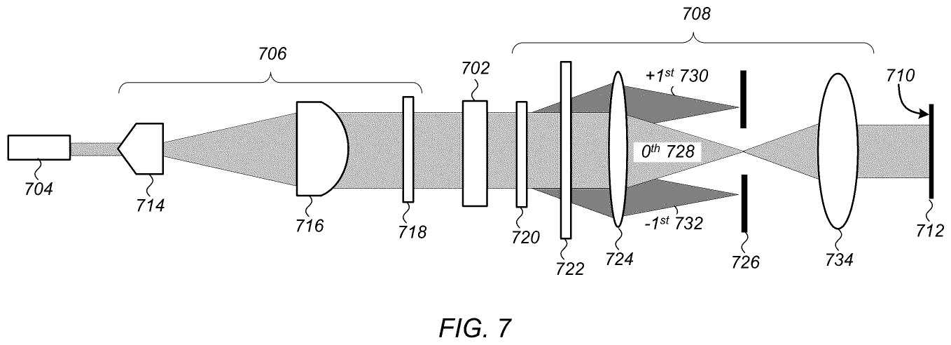

FIG. 7 is an unfolded optics diagram illustrating illumination and imaging light paths along a vertical or longitudinal axis of a linear array for a laser marking system showing the separation of a 0^{th} order beam in the modulated light from 1^{st} order beams. For purposes of clarity and to simplify the drawings the optical light path is shown as being unfolded causing the SLM 702 to appear as transmissive. However, as noted above, it will be understood that because the SLM 702 is reflective the actual light path is folded to an acute angle at the SLM.

Referring to FIG. 7, the light path begins at a laser 704 and passes through anamorphic illumination optics 706, to illuminate a substantially linear portion of a linear array of the SLM 702, and imaging optics 708 to focus the modulated light onto a surface 710 of a workpiece 712. In some embodiments, such as that shown, the illumination optics 706 are anamorphic illumination optics and can include a Powell lens 714, a long axis collimating lens 716, and a cylindrical, short axis focusing lens 718 to shape or focus the illumination into a substantially rectangular beam or line of illumination extending substantially uniformly across the linear array of the SLM 702. The imaging optics 708 can include a number of cylindrical lens 720 to direct modulated light to one or more galvanometric mirrors 722, a first Fourier Transform (FT) lens 724, a Fourier aperture 726 to separate a 0^{th} order beam 728 in the modulated light from ±1^{st} order beams 730, 732, and a second inverse Fourier Transform (FT) lens 734.

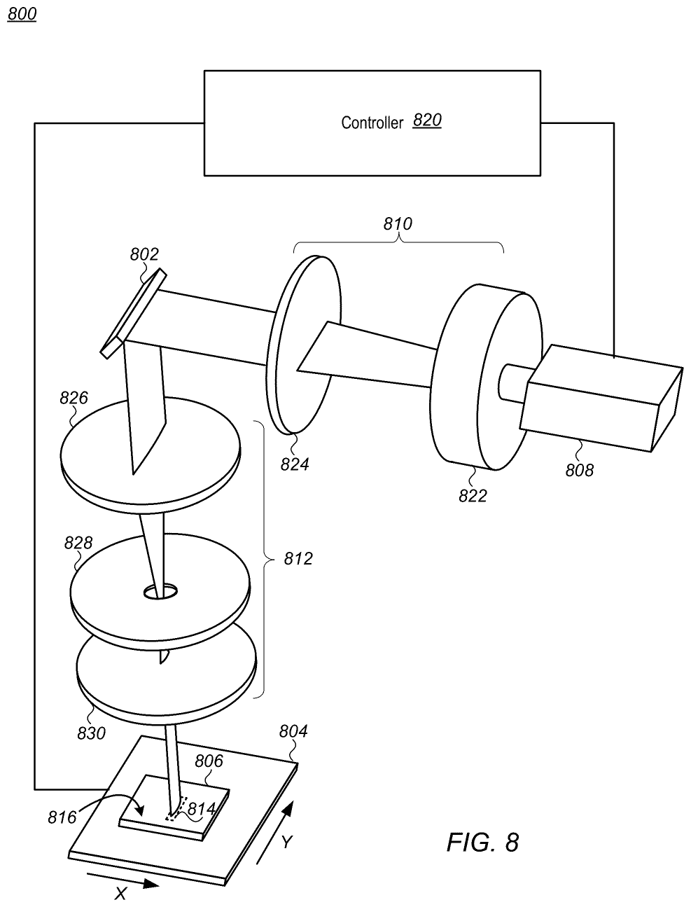

FIG. 8 is a schematic block diagram of another embodiment of a laser marking system 800 including an SLM 802 with a multi-pixel, linear array of MEMS based diffractors, and a moving fixture or stage 804 to which a workpiece 806 can be affixed. Referring to FIG. 8, the laser marking system 800 further includes a laser 808 operable to generate laser light used to illuminate the SLM 802, illumination optics 810 to direct laser light onto the SLM, imaging optics 812 operable to focus a substantially linear swath of modulated light 814 onto a surface 816 of the workpiece 806 on or affixed to the movable fixture or stage 804, and a controller 820 operable to control the SLM, laser and movable stage to scan the linear swath of modulated light across the surface of the workpiece to record a 2D image thereon.

As noted above, the laser 808 is capable of operating in UV wavelengths of from 355 nm through IR wavelengths up to about 2000 nm in either CW mode, or in a pulse mode with widths or durations of from about 1 fs up to about 500 ns at a repetition rate of from about 10 kHz up to about 300 kHz, and at energy ranges of from about 10 microjoules (μJ) up to greater than 10 millijoules (mJ).

The SLM 802 can include a multi-pixel; linear array of MEMS based, ribbon-type diffractors, such as shown in FIGS. 2A through 2C, or a multi-pixel, linear array of 2D diffractors, such as shown in FIGS. 3A through 3C and FIG. 4.

The illumination optics 810 can include a beam forming optical system 822 to direct a substantially rectangular beam onto the SLM 802. Although not shown in this figure, elements of the beam forming optical system 822 can include a Powell lens and a long axis collimating lens, as shown in FIGS. 5 and 7. The illumination optics 810 can further include a cylindrical, short axis focusing lens 824 to direct or focus the rectangular beam substantially uniformly across the linear array of the SLM 802.

The imaging optics 812 can include a first Fourier Transform (FT) lens 826, a Fourier aperture 828 to separate a 0^{th} order beam in the modulated light from ±1^{st} order beams, and a second inverse Fourier Transform (FT) lens 830 to focus the modulated light onto the surface 816 of the workpiece 806. As in the embodiments described above, the FT lenses 826, 830, of the imaging optics 812 can include fused silica lenses to reduce thermal focus shift of the modulated light focused onto the surface 816 of the workpiece 806. In some embodiments, one or more of the elements of the beam forming optical system 822 the focusing lens 824 of the illumination optics 810 can also include fused silica lenses to reduce thermal focus shift of the laser light focused onto the SLM 802.

The fixture or stage 804 on which the workpiece 806 to be marked is placed or affixed can move or at least along a first or X-axis relative to the stationary, substantially linear swath of modulated light 814 to perform a single-stripe scan as described above with reference to FIG. 6A. More preferably, the stages 804 is further operable to reposition the workpiece 806 held thereon relative to the linear swath of modulated light 814 along a second or Y-axis parallel to the long axis of the linear swath to perform one of the multi-stripe scans as described above with reference to FIGS. 6B and 6C.

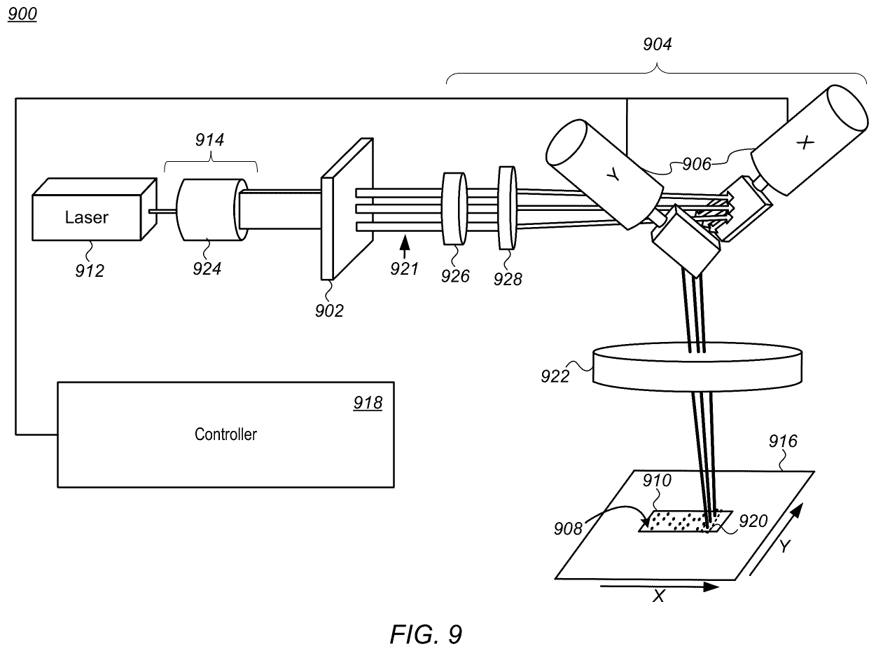

FIG. 9 is a schematic block diagram of another embodiment of a laser marking system 900 including an SLM 902 with a multi-pixel, linear array of MEMS based diffractors, and with imaging optics 904 including optical elements operable to focus a modulated light beam before the galvanometric mirrors 906 used to scan the modulated light beam across a surface 908 of a workpiece 910. As with the embodiment shown and described above with reference to FIGS. 5A and 5B, for purposes of clarity and to simplify the drawings the optical light path is shown as being unfolded causing the SLM 902 to appear as transmissive. However, it will be understood that because the SLM 902 is reflective the actual light path is folded to an angle of 90° or less at the SLM.

Referring to FIG. 9, the laser marking system 900 further includes a laser 912 operable to generate laser light used to illuminate the SLM 902, illumination optics 914 to direct laser light onto the SLM, a static fixture 916 on which the workpiece 910 to be marked is placed or affixed, and a controller 918 operable to control the SLM, laser and the galvanometric mirrors 906 to scan a swath of modulated light 920 across the surface 908 of the workpiece to record a 2D image thereon. It is noted that although modulated from the SLM 902 through the imaging optics 904 is shown as separate beams of modulated light or beamlets 921 to represent light and dark modulated light from individual pixels or groups of pixels, as in embodiments of the laser marking systems 500, 800, described above the imaging optic 904 of the laser marking system 900 are operable to illuminate a substantially linear or rectangular swath of modulated light 920 on the surface 908 of the workpiece 910. Optionally, as in the embodiment shown, the laser marking system 900 can further include a window 922 in an enclosure (not shown) enclosing the laser marking system to protect the galvanometric mirrors 906.

As noted above, the laser 912 is capable of operating in UV wavelengths of from 355 nm through IR wavelengths up to about 2000 nm in either CW mode, or in a pulse mode with widths or durations of from about 1 fs up to about 500 ns at a repetition rate of from about 10 kHz up to about 300 kHz, and at energy ranges of from about 10 microjoules (μJ) up to greater than 10 millijoules (mJ).

As also noted above, the SLM 902 can include a multi-pixel; linear array of MEMS based, ribbon-type diffractors, such as shown in FIGS. 2A through 2C, or a multi-pixel, linear array of 2D diffractors, such as shown in FIGS. 3A through 3C and FIG. 4.

The illumination optics 914 can include a beam forming optical system 924 to form and direct a substantially rectangular beam substantially uniformly across the linear array of the SLM 902. Although not shown in this figure, elements of the beam forming optical system 924 can include a Powell lens and a long axis collimating lens, as shown in FIGS. 5 and 7.

In accordance with the present embodiment the imaging optics 904 include a first focusing cylinder lens 926 located before the galvanometric mirrors 906 to focus light along an X-axis at the surface 908 of the workpiece 910, where the X-focus determines a width of the swath of modulated light 920, and a second focusing cylinder lens 928 to focus light along a Y-axis, where the Y-focus determines a height of the swath of modulated light.

Finally, as in the embodiments described above, the lenses 926, 928, of the imaging optics 904 can include fused silica lenses to reduce thermal focus shift of the modulated light focused onto the surface 908 of the workpiece 910. In some embodiments, one or more of the elements of the beam forming optical system 924 of the illumination optics 914 can also include fused silica lenses to reduce thermal focus shift of the laser light focused onto the SLM 902.

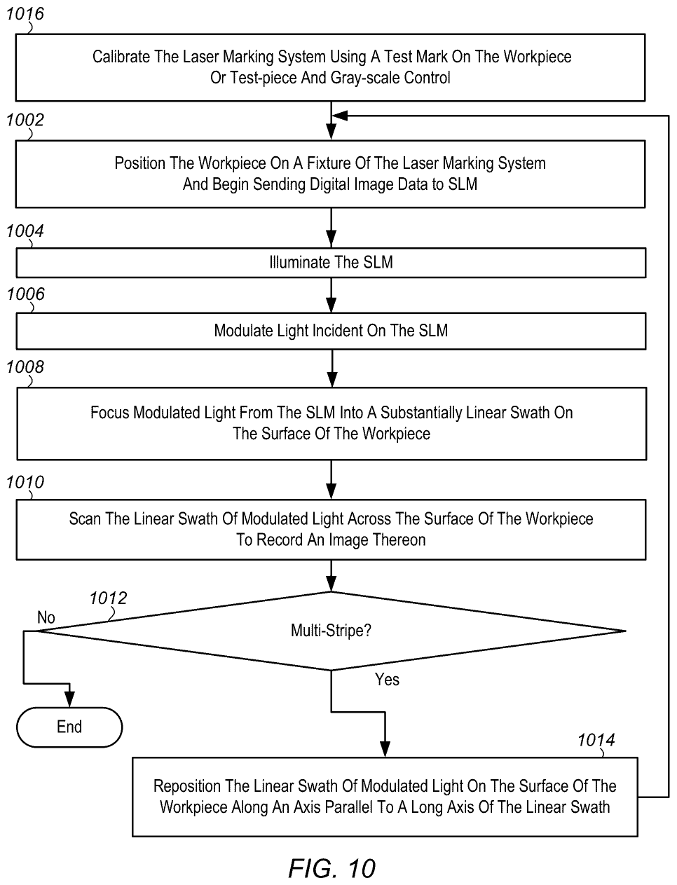

FIG. 10 is a flowchart of a method for modifying or marking a surface using a laser marking system including a MEMS based SLM. Referring to FIG. 10, the method begins with positioning a workpiece on a fixture of a laser marking system, and beginning to send digital image data to a SLM of the laser marking system (1002). When it has been detected that the workpiece is positioned on the fixture, digital image data received by the SLM, and the diffractors settled, generating light from a laser (1004). Generally, this can be accomplished by sending a pulse of the appropriate duration to the laser through a control bus. Next, light from the laser is optically coupled to the SLM to substantially uniformly illuminate a linear array of the SLM, and light incident on the SLM modulated (1006). Modulated light from the SLM is then projected and focused into a substantially linear swath on a surface of the workpiece using imaging optics; the linear swath includes light from multiple pixels of the SLM (1008). Next, the laser, SLM, and a scanner or galvanometric mirrors in the imaging optics operated to scan the linear swath of modulated light across the surface of the workpiece to record an image thereon (1010). It is then determined if a multi-stripe is necessary or desired (1012). If a multi-stripe is not necessary, i.e., if a single-stripe scan is sufficient to record the desired image, the process ends. If a multi-stripe is necessary, due either to a size of the image, a length of the linear swath of modulated light, or a desired resolution or contrast in the image recorded, the linear swath of modulated light is repositioned or indexed on the surface of the workpiece along an axis parallel to a long axis of the linear swath (1014) and the process repeated.

Optionally, as in the embodiment shown in FIG. 10, the method can further include an initial calibration step (step 1016), in which the laser marking system is calibrated using test mark or pattern either on the workpiece or a test-piece positioned on the fixture, adjusting a for each pixel a precise dosage of light projected onto the workpiece using gray-scale control of modulated light intensity to calibrate for non-uniformities in the light. Evaluation of the test mark can be accomplished either manually by a user of the laser marking system or automatically using a scanner or camera integrated into the system.

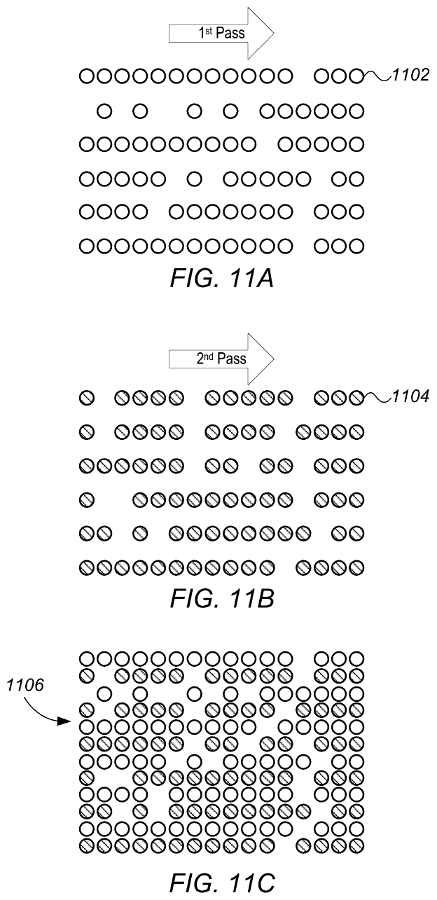

FIGS. 11A through 11C are schematic block diagrams illustrating a method of modifying or marking a surface using interleaving of two or more scans of the surface. 20. Referring to FIG. 11A the method begins with controlling the laser, SLM, and imaging optics of the laser marking system to scan a linear swath of modulated light across the surface of the workpiece in a 1^{st} pass to mark a first number of spots 1102 in first locations, and, referring to FIG. 11B, at a second time in a 2^{nd} pass to mark a second number of spots 1104 in second locations, interleaved with the first locations to record a desired image 1106, as shown in FIG. 11C. In these figures, the SLM modulates along a vertical or Y-direction, while the workpiece is scanned in a horizontal or X-direction. It will be understood this is method reduces a thermal load on the SLM and imaging optics.

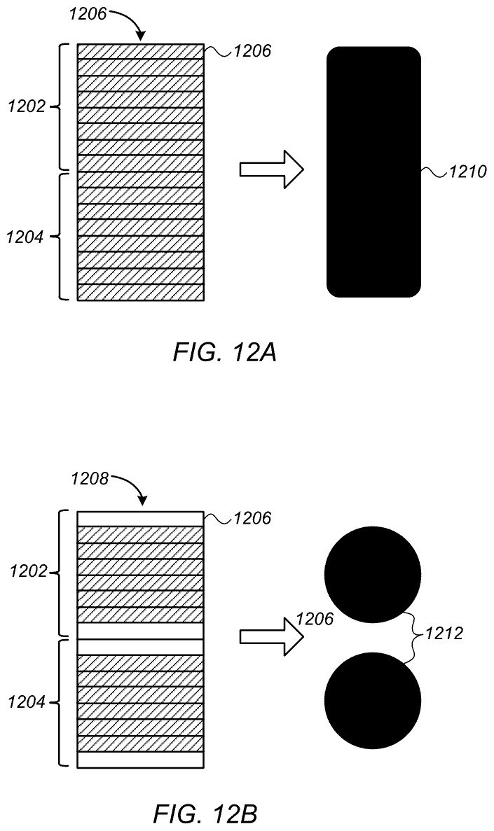

In another embodiment, the method can further include pixel shaping to improve resolution in images having high density patterns. FIGS. 12A and 12B are schematic block diagrams two adjacent groups 1202, 1204 of eight pixels 1206 in a linear array 1208 of MEMS based 2D diffractors, such as an LPLV™, illustrating a pixel shaping method for recording an image with a high density pattern. Referring to FIG. 12A it is seen that when all eight pixels 1206 in adjacent groups 1202, 1204, are on in an attempt to record adjacent dots on a surface of a workpiece, crosstalk between the groups of pixels result in a printed line 1210 rather than the desired adjacent dots. By turning off adjacent pixels 1206 between the adjacent groups 1202, 1204, resolution is improved resulting in the desired adjacent dots 1212, as shown in FIG. 12B.

In another aspect a high-throughput laser manufacturing or marking system using a programmable multi-spot modulated line beam capable of greater than a thirteen times throughput enhancement over a single-spot system is provided. While commercially available lasers have been rapidly growing in output energy and power, single-spot marking systems cannot take full advantage of higher laser outputs without causing damage to the SLM of the conventional single-spot marking system and/or the material of the substrate being marked. In contrast, the high-throughput laser marking system disclosed herein provides high throughput, high resolution marking on a variety of surfaces including stainless steel and polymer.

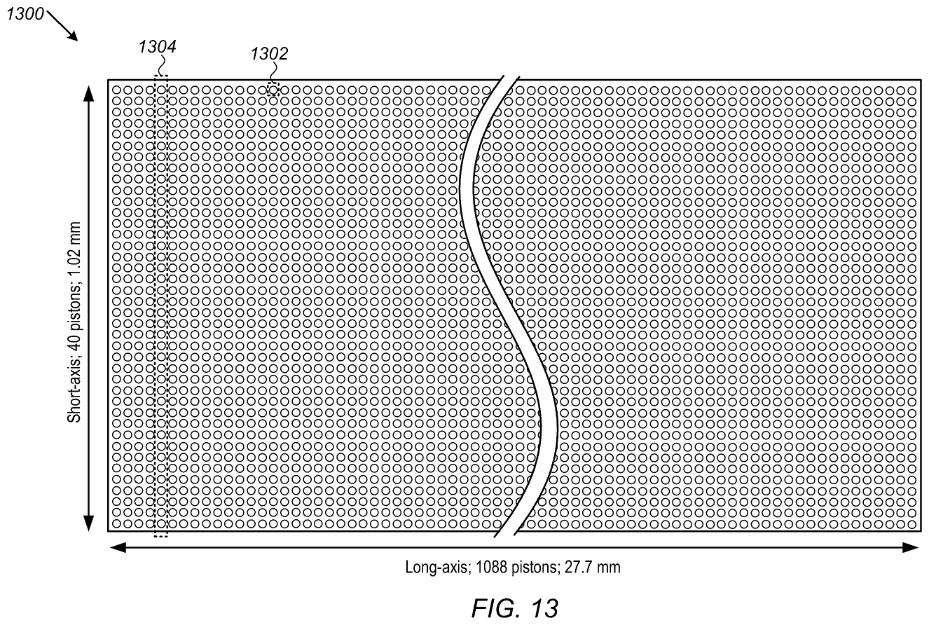

Generally, the high-throughput t laser marking system uses a programmable, digital spatial light modulator including a linear array of two-dimensional (2D) diffractors to form a planar light valve (PLV™) capable of imaging a multi-spot modulated line beam on workpiece or surface. FIG. 13 is a schematic block diagram of a top view of the optical area of one such a PLV™. Referring to FIG. 13 the PLV™ 1300 is composed of a tiled array of 2D diffractors or circular pistons 1302 enclosed by a static faceplate, such as shown in FIG. 3A-3C and described above. In the embodiment shown the PLV™ 1300 is a 1088-pixel device arranged in a linear configuration, each pixel 1304 including 40 electrically ganged 2D diffractors or pistons with a single element width of 25.5 μm arranged in a single column to make a 1,020 μm tall pixel along a short axis of the device. A long axis of the PLV™ 1300 includes 1,088 pixels 1304 for a total length of 27.7 mm. The PLV™ 1300 utilizes a diffraction mechanism to modulate light by directing it into different diffraction orders. Since the full 40 piston length of each pixel 1304 can be used to modulate light, the PLV™ 1300 has a large optical area, and light is spread out over the entire PLV™ to keep the optical power density or fluence at a surface of the PLV™ low, while the modulated light is condensed into a thin line having a much greater fluence at the work surface using anamorphic optics. For example, it is noted that a laser marking system including a PLV™ with the dimensions of that shown in FIG. 13, is operable to produce a peak fluence (Fₚₑₐₖ) at the work surface of 0.6 J/cm², sufficient for marking stainless steel, while a fluence at the surface of the PLV™ is less than one tenth that of a threshold at which damage to the PLV™ would occur.

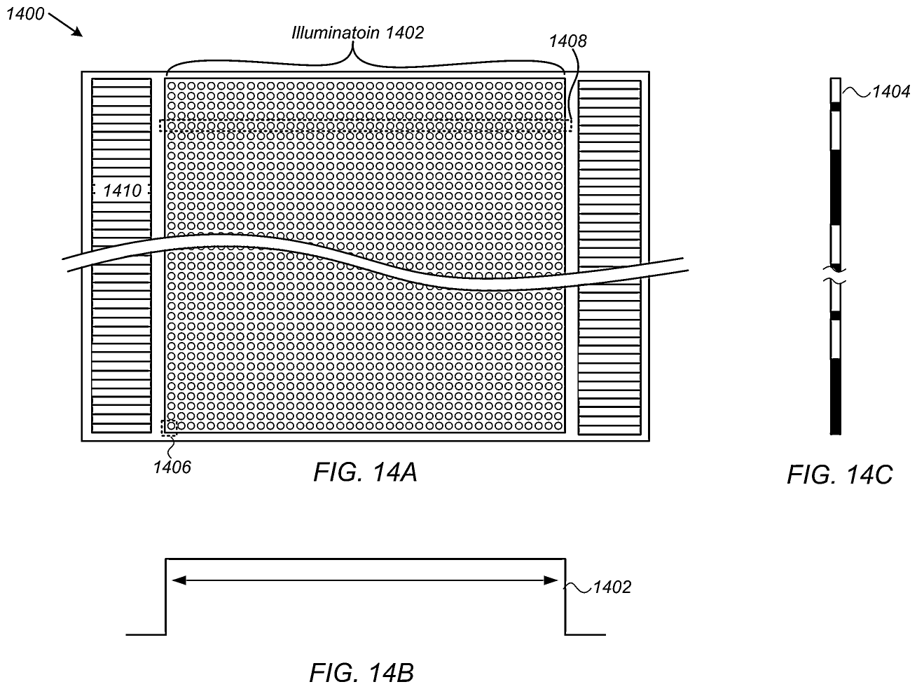

FIG. 14A is a schematic block diagram of a top view of a portion of a PLV™ 1400 of a high-throughput laser marking system, FIG. 14B is a schematic illustration of top-hat illumination 1402 projected onto an optical area of the PLV™, and FIG. 14C is a schematic illustration of a condensed line beam 1404 of modulated light at a workpiece surface generated by the PLV™ 1400.

Referring to FIG. 14A, the PLV™ 1400 generally includes a number of individual 2D diffractors 1406, each comprising a piston and an adjacent area of a static faceplate as shown and described with reference to FIGS. 3A-3C, arranged in a single column along a short axis of the PLV™ to form a single, tall pixel 1408 in a multi-pixel linear array of pixels arranged along a long axis of the PLV™. The PLV™ 1400 is capable of supporting up to 200 kHz modulation between fully reflecting and diffracting states, with top-hat illumination 1402 at pulse energies of 920 μJ with pulse widths down to 200 femtoseconds and a continuous wave (CW) power of 1 kW at wavelengths of 355-1070 nm. By top-hat illumination 1402 it is meant that illumination optics (not shown in these figures) of the laser marking system is operable to substantially uniformly illuminate the rectangular multi-pixel linear array of pixels 1408 having a top-hat profile shown in FIG. 14B along both the short axis and long axis of the PLV™.

The PLV™ 1400 further includes a number of drive channels or drivers 1410, each electrically coupled to the electrically ganged 2D diffractors 1406 in a single pixel 1408, and configured or operable to drive the diffractors to modulate a phase and/or amplitude of the light incident thereon. The drivers 1410 can be integrally formed on a common substrate with the optically active array of pixels 1408, as shown, or on a separate substrate in a multi-chip module and electrically coupled thereto. Generally, the drivers 1410 are configure to deflect from a reflective surface of the pistons of the diffractors 1406 in a pixel 1408 from a reflective surface of the adjacent static faceplate by a distance between 0 and an odd multiple of a quarter wavelength (λ/4) of the incident light.

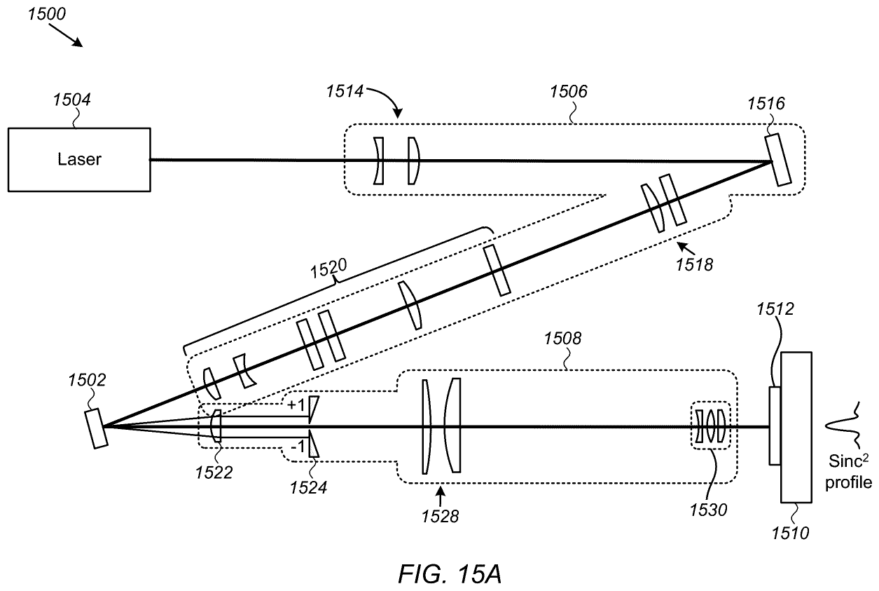

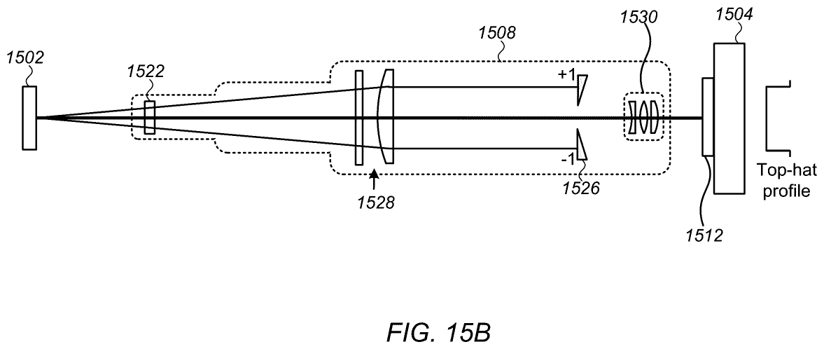

FIGS. 15A and 15B illustrate an optical schematic of a laser marking system 1500. FIG. 15A illustrates the laser marking system along a short axis of the PLV™ 1502. Referring to FIG. 15A, the laser marking system of an illumination light source, such as a laser 1504, illumination optics 1506 and imaging or projection optics 1508 and a stage 1510 on which a workpiece 1512 to be marked is held. The illumination optics 1506 take a Gaussian beam input from the laser 1504 and create a rectangular beam at the PLV™ 1502 having a top-hat profile along both long and short axis of the PLV™.

The laser marking system 1500 device modulates pixel intensity by sending light into higher diffraction orders at fixed angles. The amount of light in the 0^{th} order is controlled by the piston displacement of each pixel. Spatial filters in the projection optics are placed to only allow the 0^{th} order light to reach the workpiece. For a given pixel, the light in the 0^{th} order will be maximized when the displacement is 0 and minimized when the displacement is an odd multiple of one quarter wavelength (λ/4) of incident light. These are known as the bright and dark states respectively. Since the diffractive elements of the PLV™ 1502 are arranged or arrayed in two dimensions, the diffraction pattern is also two dimensional. It is easiest to filter the two axes independently using slit apertures at the Fourier planes of different lenses in the projection optics 1508.

The laser 1504 can include, for example, a Fianium Hylase™, 20 W, 10 ps, 1064 nm laser, commercially available from NKT Photonics Corp. of Bikerød, Denmark, or a Photonics Industries RX2-series™, 100 W, 10 ps, 1064 nm laser, commercially available from Photonics Industries International, Inc. of Ronkonkoma, New York. It is noted that because the laser light is spread out over the entire PLV™ 1502, the power density of optical energy at work surface can have a peak fluence (Fₚₑₐₖ) of 0.6 J/cm², sufficient for marking stainless, while the fluence at the surface of the PLV™ 1502 is 10 times less than the threshold for damaging the PLV™.

The illumination optics 1506 include a beam expander 1514, including a number of refracting, dispersive and cylindrical lenses, to disperse a collimated beam from the laser 1504, a mirror 1516, a top-hat shaper 1518, including a number of anamorphic, cylindrical and Powel lenses, to shape the dispersed laser light into illumination having a 2D rectangular top-hat profile, and a cylindrical telescope 1520, including a number of lenses, to direct the top-hat illumination onto the PLV™ 1502 to substantially uniformly illuminate a rectangular multi-pixel linear array of pixels.

The projection optics 1508 are anamorphic projection optics operable or configured to relay or project an anamorphic image of the PLV™ 1502 on to the surface of the workpiece 1512 having a length along the long-axis 2 to 20 times smaller than the PLV™ and tightly focused along the short-axis to have a sinc² profile a width less than a minimum desired feature size. The projection optics 1508 include a cylindrical focus lens 1522, a first spatial filter 1524 and a second spatial filter 1526 to cut off the +1 and higher diffraction orders allowing only 0^{th} order light to reach the workpiece 1512, a tube lens 1528, and an objective lens 1530.

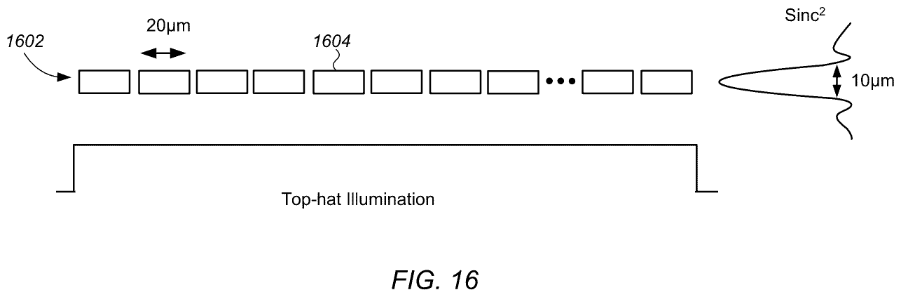

The projection optics 1508 relay an anamorphic image of the PLV™ 1502 to the surface of the workpiece 1512. The lenses and optical elements of the projection optics 1508 are operable to image the long-axis of the PLV™ 1502 on to the workpiece 1512 and condense the short-axis into a tightly focused line. This results in a condensed line beam 1602, shown in FIG. 16, of modulated light at a workpiece surface. The line beam 1602 has a top-hat profile along the long axis with a number of line beam pixels or contiguous segments 1604 that represent a predetermined or preselected minimum feature size, and are intensity controlled by one or more pixels of the PLV™ (PLV™ pixels), electrically ganged together. Note, the separation between contiguous segments 1604 is exaggerated in this figure for purposes of illustration only. In practice there is substantially no separation between the contiguous segments 1604. Each of these contiguous segments 1604 can be made up by electrically ganging together one or more pixels of the PLV™. For the exemplary laser marking system shown in FIGS. 15A and 15B and having a PLV™ as shown in FIG. 13, a minimum feature size of 20 μm is targeted, and each contiguous segments 1604 is formed by modulated light from 8 adjacent PLV™ pixels, each having width along a short axis of the PLV™ pixel of 2.5 μm. The condensed line beam 1602 has a sinc² profile along a short-axis, with a 1/e² diameter of 10 μm (about half the minimum feature size) was targeted so that when the line beam 1602 is scanned, either using galvanometric mirrors or a moving X-Y stage as described herein after, the pulses of modulated light overlap in the short-axis direction.

The condensed line beam dimensions will depend on the laser energy, as the beam must be small enough to reach a predetermined target fluence. The peak fluence, Fₚₑₐₖ, for the line beam is given by the following equation:

$${F}_{p e a k} = \frac{{E}_{p u l s e}}{{ω}_{s i n c} \cdot L}$$

where Eₚᵤₗₛₑ is the pulse energy, ω_{sinc} is the distance from the center of the line beam to the first 0^{th} diffraction order in the short-axis, and L is the length of the long-axis of the line beam.

For example, for a laser marking system for marking stainless steel in which a peak fluence (Fₚₑₐₖ) of 0.6 J/cm² is targeted, and a minimum feature size of 20 μm is chosen, with a short-axis 1/e² diameter of 10 μm (ω_{sinc≈}7.1 μm). As noted above, the short-axis diameter must be less than the desired feature size because the pulses are overlapped in that direction. Thus, for a 20 W laser outputting 100 μJ pulses at 200 kHz, a pulse energy of 50 μJ at the surface of the workpiece is assumed when accounting for 50% system throughput. From this a suitable line beam length can be calculated as follows:

$$L = \frac{{E}_{p u l s e}}{{ω}_{s i n c} \cdot {F}_{p e a k}} = \frac{50 μ J}{7.1 μ m \cdot 0.6 J / {cm}^{2}} = 1.17 mm$$

Thus, if the full 27.7 mm length of a PLV™ such as that shown in FIG. 13, were imaged to a 1.17 mm long beam line, a demagnification of 24×would be required, resulting in a very short working distance. Instead, the illumination optics 1506 are designed to illuminate 10 mm of the PLV™ 1502, and projection optics 1508 are designed with a demagnification of 10× to create a 1 mm long line. With this demagnification, a 25.4 μm PLV™ pixel becomes 2.54 μm at the surface of the workpiece 1512. So, eight (8) PLV pixels may be ganged or grouped together to control a 20.3 μm segment 1604 of the line beam 1602 to create the desired feature size.

Where the laser 1504 is a more powerful 100 W laser operable to produce an output of 200 μJ pulses at 500 kHz, the illumination optics 1506 are changed to illuminate 20 mm of PLV, with the same 10×projection optics 1508 to create a 2 mm long beam line.

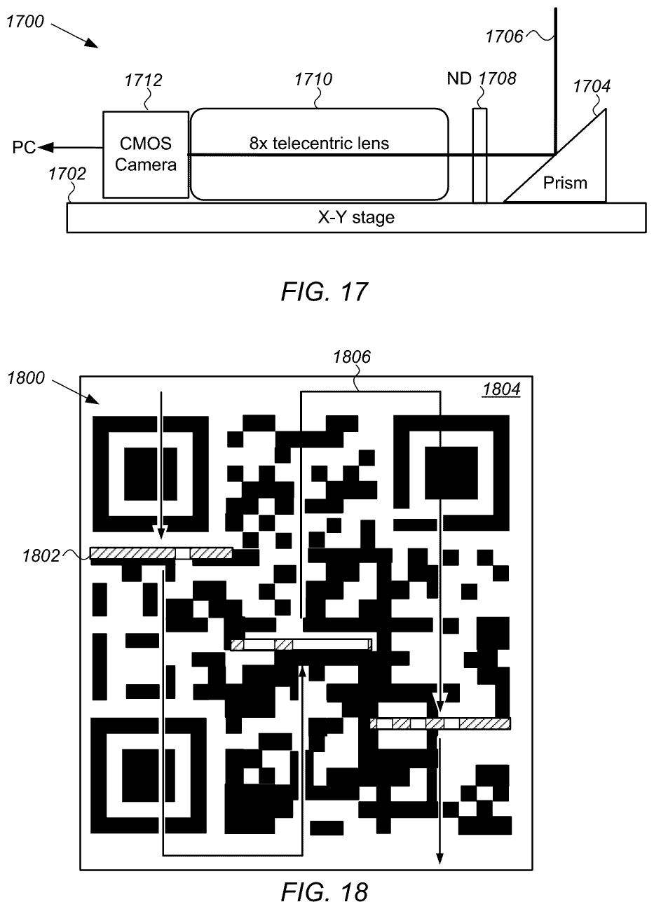

In some embodiments, the laser marking system can further include a calibration system, as shown in FIG. 17, mounted on an X-Y stage to view the line beam at a work surface. One embodiment of such a calibration system 1700 is shown in FIG. 17. Referring to FIG. 17 the calibration system 1700 generally includes mounted to or positioned on an X-Y stage 1702 a prism 1704 to redirect light 1706 from the line beam through dimming optics (ND 1708) to attenuate the light, followed by an imaging lens 1710, such as an 8× telecentric lens, and a CMOS camera 1712. Information on intensity from the CMOS camera 1712 is coupled to a controller or computer (PC) operable to control the PLV™ and is used to find appropriate drive voltages for each pixel for bright and dark states, as well as to compensate for non-uniformities in the illumination along the long-axis of the PLV™.

A method for operating the laser marking system to create a 2D image on a surface of a workpiece larger than the length of the condensed line beam will now be described with reference to FIG. 18. Referring to FIG. 18, the 2D image 1800, shown here as a QR code, is built up by scanning the line beam 1802 across a surface of a workpiece 1804. If the width of the image 1800 is greater than the length of the line beam 1802, the line beam must be scanned multiple times with a small overlap at the edge of the line beam. FIG. 18. shows the line beam 1802 following a serpentine path 1806 to mark the image 1800. The line beam 1802 is shown at three different points in time. The shaded segments show where the line beam is bright to create t mark, while the white segments show where the line beam is dark. The pattern of the line beam is updated as the beam is scanned to build up the full image.

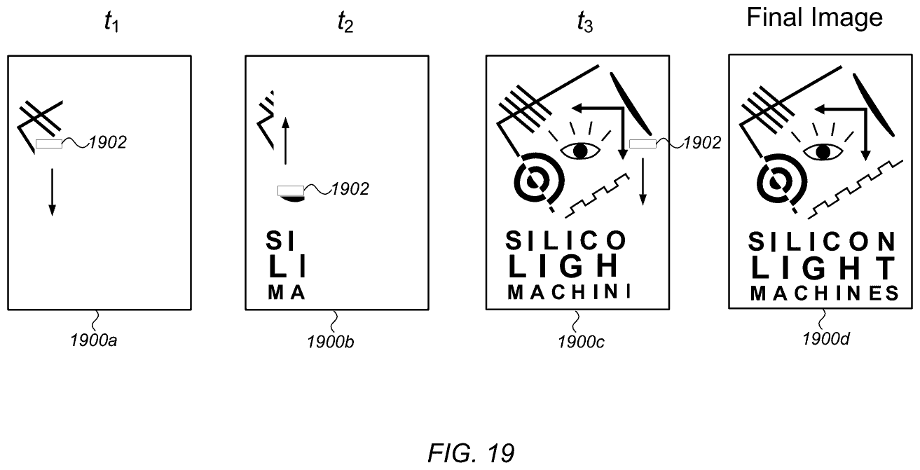

FIG. 19 shows a series of images 1900a, 1900b and 1900c further illustrating a method for using the laser marking system to form a completed image 1900d larger than a line beam 1902 using a serpentine scan path. The arrows in the image denote the scan direction. Generally, as with the embodiment of the method described with reference to FIG. 18 there is a small overlap at the edge of the line beam 1902 to substantially eliminate a stitch boundary between adjacent scans of the line beam.

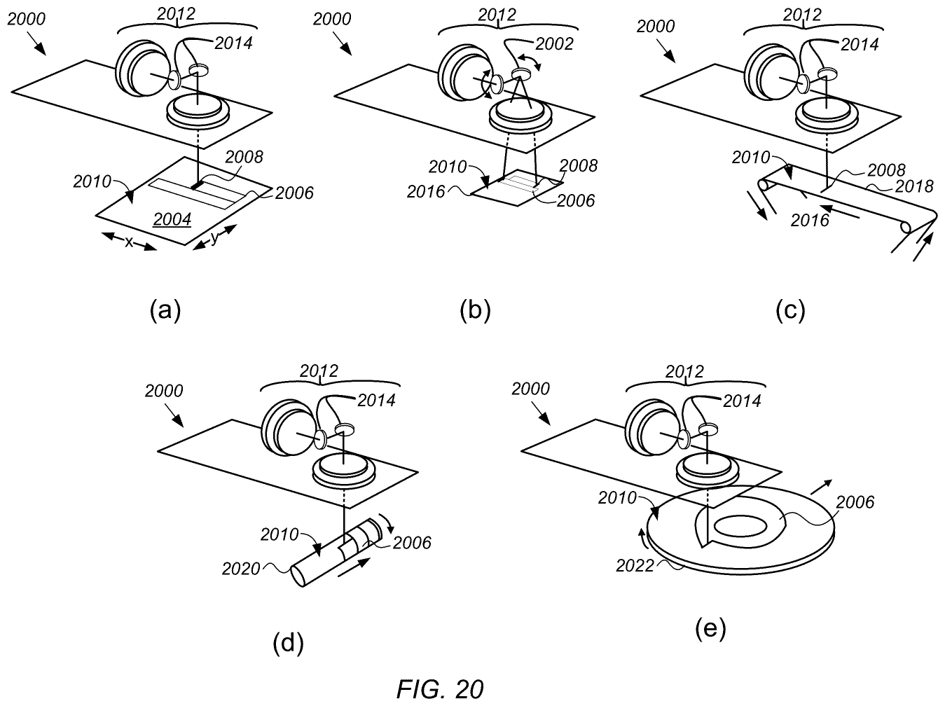

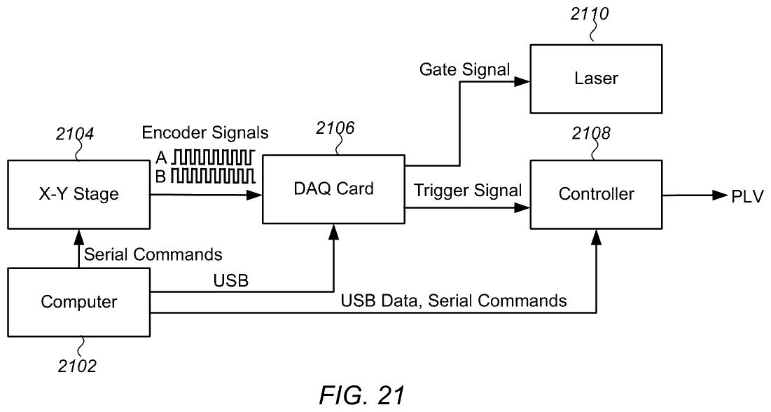

Systems and methods for providing relative movement between a line beam and an X-Y stage on which a work piece is held to build up a 2D image on the surface thereof will be described with reference to FIGS. 20A-20E and FIG. 21.

FIGS. 20A-20E are schematic block diagrams of embodiments of a laser marking system 2000 including a number of galvanometric mirrors 2002 or movable x-y stages 2004 the for creating 2D images 2006 larger than a width of a line beam 2008 scanned across the surface of the workpiece 2010. The galvanometric mirrors 2002 or movable x-y stages 2004 reposition or provide relative motion between the line beam 2008 and the workpiece 2010 to enable scanning a second or subsequent swaths over the surface of the workpiece. It will be understood that the galvanometric mirrors 2002 and movable x-y stages can be combined to cover larger areas creating larger 2D images 2006. For example, each of the embodiments of the laser marking system 2000 shown can include at least one galvanometric mirror for scanning a swath of the surface of the workpiece, and a movable stage operable to move along a single axis in direction perpendicular to the swath to enable scanning second or subsequent swaths.

Referring to FIG. 20A in a first embodiment the projection optics 2012 of the laser marking system 2000 include fixed mirrors 2014 to direct the line beam 2008 onto the surface of a workpiece 2010 held on a movable x-y stage 2004. The x-y stage 2004 is then moved in synchronization to modulation of the line beam 2008 to build up the 2D image.

In another embodiment shown in FIG. 20B stage on which the workpiece 2010 is held is a fixed stage 2016 and the projection optics 2012 of the laser marking system 2000 include galvanometric mirrors 2002 to direct the line beam 2008 onto the surface of a workpiece 2010. The galvanometric mirrors 2002 are then moved in synchronization with modulation of the line beam 2008 to build up the 2D image.

In other embodiments shown in FIGS. 20C to 20E the projection optics 2012 of the laser marking system 2000 include fixed mirrors 2014 or a single galvanometric mirrors 2002 to direct the line beam 2008 onto the surface of a workpiece 2010 held on a movable x-y stage 2004 or workpiece 2010. More particularly, in FIG. 20C the projection optics 2012 of the laser marking system 2000 include fixed mirrors 2014 to direct the line beam 2008 onto the surface of a roll-to-roll movable workpiece 2018. In FIG. 20D the workpiece 2010 is held on a rotating drum 2020 that is capable of being both rotated and moved axially in synchronization with modulation of the line beam 2008 build up the 2D image. In FIG. 20E the workpiece 2010 is held on a rotating or spinning disc 2022 and the projection optics 2012 of the laser marking system 2000 include at least one galvanometric mirror 2002 capable of moving the line beam 2008 radially with respect to an axis of the spinning disk in synchronization with the spinning and modulation of the line beam 2008 build up the 2D image.

The PLV™ pattern of the modulated line beam must be synchronized with the X-Y stage motion and/or galvanometric mirrors to create 2D images. FIG. 21 is a block illustrating communications flow in the laser marking system to synchronize a PLV™ pattern with X-Y stage motion. Referring to FIG. 21, a computer 2102, such as a personal computer (PC) initializes the X-Y stage 2104, data acquisition (DAQ) card 2106 and a SLM or PLV™ controller 2108 in the laser marking system. The X-Y stage 2104 is moved to an initial position. The PLV™ controller 2108 is loaded with the full pattern data and then is set to wait for a frame trigger signal at the start of each pass and a column trigger signal when the pattern should update. The DAQ card 2106 is set to read encoder signals from the X-Y stage 2104 and control an output of the laser 2110 using a gate signal, update the pattern to the PLV™ controller 2108 using the trigger signals based on the X-Y stage 2104 position. The computer 2102 provides data and commands, including image or pattern data, to the PLV™ controller 2108 and to the DAQ card 2106 via one or more universal serial bus (USB) connections. Typically, the laser 2110 is enabled only inside a marking area with a 50-100 μm buffer on either end where the PLV™ (not show in this figure) is set to a dark state. The PLV™ controller 2108 receives a column trigger at a periodic interval of, e.g. 5 μm. Once communication is established and all components are set up, the X-Y stage 2104 is commanded to move which causes the DAQ card 2106 to signal or trigger the PLV™ controller 2108 and the laser 2110. At the end of each pass, the X-Y stage 2104 is moved along the long-axis of the line beam with a small overlap, e.g. 20 μm to the previous pass. Scans continue until the full marked image is created.

### Image Processing

The PLV™ controller 2108 takes a 2D array of 10-bit values to set the amplitude of each pixel. For example, the array can include 1,088 rows (one for each pixel in the PLV™) and a number of columns equal to the number of pattern updates for the line beam needed to write the image. So, the image file on the computer 2102 must be processed through several steps to ready it for the PLV™ controller 2108. First, the image is oriented so that its longest dimension is along the direction of the scan. This minimizes the number of times the stage must be accelerated, and results in the fastest write time.

If the image file on the computer 2102 is a grayscale image, such as a black and white photo, it is converted to a binary image through Atkinson dithering. This creates a grayscale effect by varying the density of marked features.

Next, the image data is divided into a number individual passes or scans of the line beam necessary to form the image. Generally, each of these individual scans include an overlapped region, in which image data at a beginning edge of scan corresponds to or duplicates that at the edge of a previous scan to substantially eliminate a stitch boundary between adjacent scans of the line beam. If scanning is to be performed in a serpentine manner with each successive scan reversing direction from the previous scan, the pattern order of the odd numbered passes is reversed. Additionally, some dark state patterns can added at the beginning and end of each scan or pass to act as a buffer region where the laser can be turned on but marking will not occur. Then, all passes are concatenated together to create a 2D array with the correct dimensions for the PLV controller. Finally, the binary data is replaced with 10-bit calibrated data for the bright and dark state of each pixel.

### Edge Placement

There are two types of resolution that affect the quality of small-scale marks. The first is a minimum feature size that can be produced by the laser marking system. The second is an amount or grid size by which the features can be shifted on each successive scan. The minimum feature size determined by the resolution of the projection optics. For example, for the laser marking system described above with reference to FIGS. 15A and 15B and having a PLV™ as shown in FIG. 13, the minimum feature size can be 20 μm by ganging or grouping eight (8) PLV pixels together and providing projection optics with a demagnification of 10×.

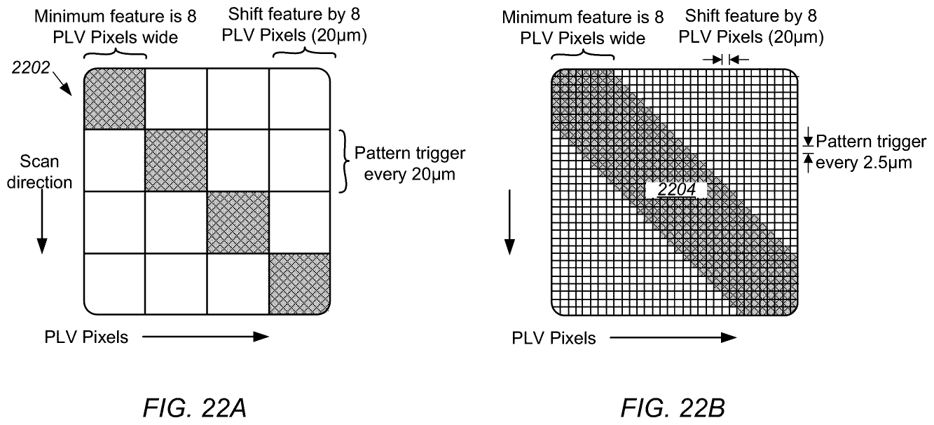

FIGS. 22A and 22B are schematic block diagrams illustrating the effect of a grid size of successive scans used to create an image on image resolution. FIG. 22A illustrates an image (shaded diagonal line 2202) formed using a laser marking system with minimum feature size of 8 PLV™ pixels or 20 μm, where each successive pattern is located on a grid equal to the minimum feature size, resulting in an image with rough edges, with an edge displacement of 20 μm on successive scans. FIG. 22B, illustrates an image (shaded diagonal line 2204) formed using the same laser marking system with the same minimum feature size, but wherein each successive pattern is shifted by a single PLV™ pixel on the next pattern update, corresponding to an edge placement change of 2.5 μm. Thus, working on a smaller grid achieves smoother edges when the edge of an image is at an angle relative to the line beam. It is noted that using a smaller grid also requires more frequent pattern updates. For example, when scanning at a speed of 50 mm/s an update every 20 μm requires a 2.5 kHz rate for updating the pattern, while an update every 2.5 μm, as shown in FIG. 22B μm requires a 20 kHz rate. However, it is further noted that this update rate is well within the capabilities of a laser marking system using a programmable, digital PLV™, which supports modulation rates of up to 200 KHz.

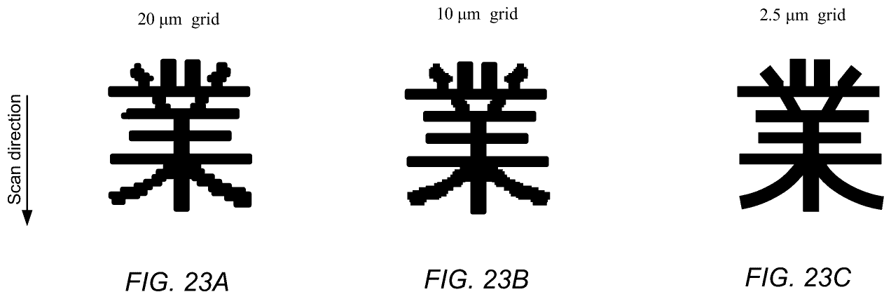

Referring to FIGS. 23A to 23C, these images all represent a 720 μm tall character made using a laser marking system with an 8 PLV™ pixel, 20 μm minimum feature size, marked different edge placement precision and illustrate the impact of edge placement or grid size on the smoothness of the features. In particular, FIG. 23A shows the character formed with a grid size or edge placement equal to that of the minimum feature size or 20 μm. FIG. 23B shows the character formed with a grid size or edge placement of 10 μm, noticeably smoother than that of FIG. 23A but still showing a staircase appearance along edges of the figure not parallel or perpendicular to the direction of a scan used to form the character. FIG. 23C shows the character formed with a grid size or edge placement of 2.5 μm, equal to one (pixel) in the PLV™ of the laser marking system used to create the image, and having substantially smooth appearance along all edges.

### Image Stitching

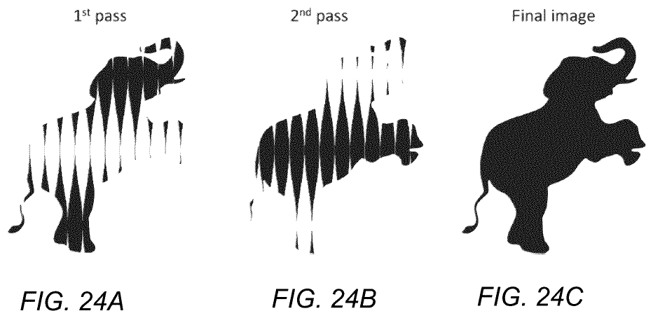

For many images a boundary between successive scans or passes is undetectable. However, images that include large solidly marked areas prove more challenging. Any non-uniformities in the line beam will be repeated each pass resulting in a pattern in the scan direction known as banding. FIG. 24A through 24C illustrate a double-pass technique in which the scan path follows a sine-wave pattern to reduce the perception of banding. In this technique a first pass, shown in FIG. 24A, is marked, followed by a second pass, shown in FIG. 24B, in which the line beam is offset in a sine-wave pattern by half of the line beam length to create the final image shown FIG. 24C. The curved interface between overlapping scans or helps to reduce the perception of any vertical banding in the final image.

The darkness and color of the image can be tuned by adjusting the spacing between pulses. For a constant repetition rate from the laser the pulse spacing can be varied by changing the scan speed.

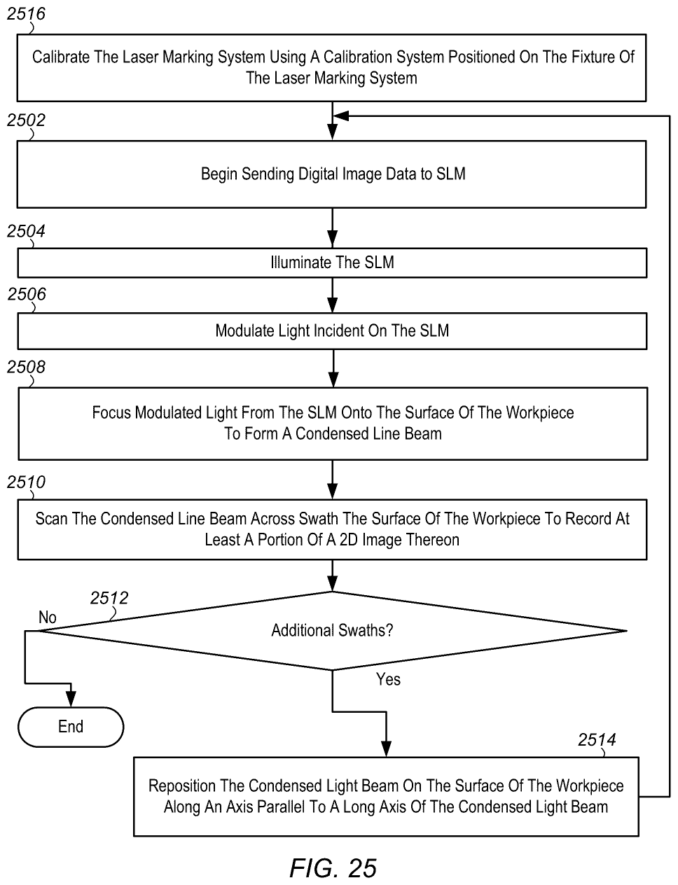

FIG. 25 is a flowchart of a method of modifying or marking a surface using a high-throughput multi-beam laser manufacturing system including a MEMS based SLM including a rectangular array of electrically actuated two-dimensional (2D) diffractors arranged to form a plurality of pixels spaced linearly along a long-axis of the SLM, each pixel including a plurality of 2D diffractors electrically ganged together and arranged along a short-axis perpendicular to the long-axis of the SLM. Referring to FIG. 25, the method begins with positioning a workpiece on a fixture of a laser marking system, and beginning to send digital image data to the SLM of the laser marking system (2502). When it has been detected that the workpiece is positioned on the fixture, digital image data received by the SLM, and the 2D diffractors settled, generating light from a laser (2504). Generally, this can be accomplished by sending a pulse of the appropriate duration to the laser through a control bus. Next, light from the laser is optically coupled to the SLM to substantially uniformly illuminate a rectangular array of the SLM, and light incident on the SLM modulated (2506). Modulated light from the SLM is then projected and focused onto a surface of the workpiece using anamorphic projection optics to form a condensed line beam (2508). The condensed line beam generally includes anamorphic image or reflection of the SLM having a sinc² profile along the short-axis with a width less than ½ a predetermined minimum feature size, and a long-axis length shorter than the SLM, and based on a pulse energy of the laser and a targeted peak fluence. Next, the laser, SLM, and a galvanometric mirror in the projection are operated to scan the condensed line beam across swath the surface of the workpiece to record at least a portion of a two-dimensional (2D) image thereon (2510). It is then determined if additional scans of additional swaths are necessary or desired to produce a 2D image having a dimension larger than the length of the condensed line beam (2512). If additional swaths are not necessary, i.e., if a single swath scan is sufficient to record the desired image, the process ends. If additional swaths are necessary, due either to a size of the image, a length of the linear swath of modulated light, or a desired resolution or contrast in the image recorded, the condensed line beam is repositioned or indexed on the surface of the workpiece along an axis parallel to a long axis of the condensed line beam (2514) and the process repeated. The condensed line beam can be repositioned either by means of a second a galvanometric mirror in the projection optics, or by movement of the fixture on which the workpiece is positioned. As noted above, the boundary between the swaths can overlap and/or have an intermeshing sine-wave pattern to minimize or substantially eliminate the appearance of vertical banding in the final image. Additionally or alternatively the second and successive swaths can overlap such that an edge of the later swath is offset from a corresponding edge of the preceding swath by a distance less than the minimum feature size to create an image having substantially smooth appearance along all edges, including edges of the image not parallel or perpendicular to the direction of a scan used to form the image.

Optionally, as in the embodiment shown in FIG. 25, the method can further include an initial calibration step (step 2516), in which the laser marking system is calibrated using, for example, the calibration system 1700 shown in FIG. 17, mounted on the fixture to view the condensed line beam at the work surface. Information on intensity from the calibration system 1700 is coupled to a controller or computer (PC) operable to control the SLM and is used to find appropriate drive voltages for each pixel for bright and dark states, as well as to compensate for non-uniformities in the illumination along the long-axis of the SLM.

Thus, embodiments of a laser marking system including a spatial light modulator (SLM) with a multi-pixel, linear array of MEMS based diffractors, and systems using the same have been described. A laser marking system has been demonstrated with up to 13.8×throughput enhancement at greater than 4×resolution (20 μm feature) as compared to a conventional 58 μm single spot system. The throughput can be further scaled with use of a more powerful laser. This system is especially well-suited for applications with densely marked features and a long aspect ratio which reduces the number of times the stage must accelerate for marking a given area. The laser marking system been used to mark stainless steel substrates and to pattern aluminum, graphite, and plastic.

Finally, it is noted the while describe in detail above with reference to a laser marking system, the high-throughput laser manufacturing system can be adapted for many laser processing applications such as additive manufacturing, lithography, and micromachining.

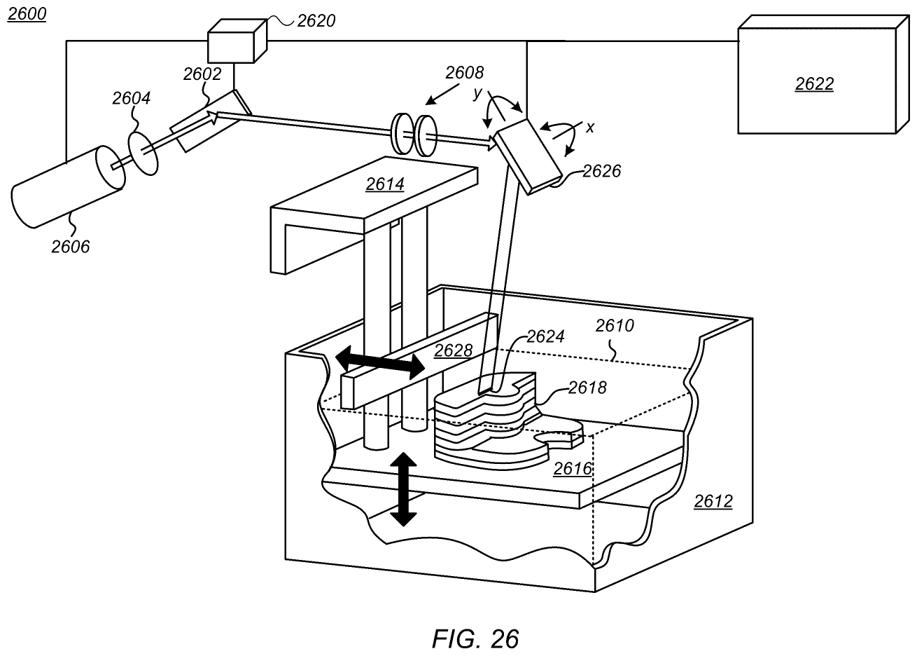

FIG. 26 is a block diagram illustrating an additive manufacturing system including a high-throughput multi-beam laser manufacturing system including a 2D PLV™ type SLM. Referring to FIG. 26, the additive manufacturing system 2600 generally includes a MEMS based SLM, such as the PLV™ 2602 described above with reference to FIGS. 13 and 14A, illumination optics 2604 operable to transmit light from a laser 2606 onto the PLV™, and projection optics 2608 to transfer modulated light from the PLV™ toward a surface 2610 (indicated by dashed lines) of a photosensitive polymer or resin in a vat 2612. Generally, as in the embodiment shown the additive manufacturing system 2600 further includes transport mechanism 2614 to raise and lower a platform or fixture 2616 on which an workpiece 2618 is formed, a SLM or PLV™ controller 2620 to control operation of the PLV™ 2602, and computer 2622 to control operation of the laser 2606 and the transport mechanism 2614.

As noted above, the laser 2606 can be a high power laser capable of operating in UV wavelengths of from 355 nm through IR wavelengths up to about 2000 nm in either CW mode, or in a pulse mode with widths or durations of from about 1 fs up to about 500 ns at a repetition rate of from about 10 kHz up to about 300 kHz, and at energy ranges of from about 10 microjoules (μJ) up to greater than 10 millijoules (mJ). In one embodiment particularly useful for additive manufacturing systems the laser 2606 is capable of operating in CW mode at wavelengths (A) of from about 350 nm to about 1550 nm, and at powers of about 500 Watts (W) to greater than about 1 kilowatt (kW).

Referring again to FIG. 26, the projection optics 2608 can include anamorphic projection optics operable or configured to relay or project an anamorphic image of the PLV™ 2602 on to the surface 2610 of the photosensitive resin in the vat 2612 to form a condensed line beam 2624 having sinc² profile along a short-axis, and a long-axis length shorter than the PLV™, and based on a pulse energy of the laser 2606 and a targeted peak fluence at the surface of the photosensitive resin. Generally the condensed line beam 2624 has a length along the long-axis 2 to 20 times smaller than the PLV™ 2602 and a tightly focused width less than about ½ of a predetermined minimum desired feature size.

In some embodiments, such as that shown, the projection optics 2608 can further include one or more galvanometric mirrors 2626 are then moved in synchronization with modulation of the condensed line beam 2624 and the transport mechanism 2614 to build up the three dimensional (3D) workpiece 2618. The modulated light converts the photosensitive resin into a solid, building successive layers or cross-sections of the 3D workpiece 2618.

Generally, the additive manufacturing system 2600 further includes a sweeper 2628 adapted to move as indicated by the horizontal arrow to spread or smooth fresh resin over surface sections of the workpiece 2618 being manufactured.

Embodiments of the present invention have been described above with the aid of functional and schematic block diagrams illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

It is to be understood that the Detailed Description section, and not the Summary and Abstract sections, is intended to be used to interpret the claims. The Summary and Abstract sections can set forth one or more but not all exemplary embodiments of the present invention as contemplated by the inventor(s), and thus, are not intended to limit the present invention and the appended claims in any way.

The breadth and scope of the present invention should not be limited by any of the above-described exemplary embodiments, but should be defined only in accordance with the following claims and their equivalents.

1. A laser manufacturing system comprising:
a spatial light modulator (SLM) including a rectangular array of electrically actuated two-dimensional (2D) diffractors arranged to form a plurality of pixels spaced linearly along a long-axis of the SLM, each pixel including a plurality of 2D diffractors electrically ganged together and arranged along a short-axis perpendicular to the long-axis of the SLM;
illumination optics operable to illuminate the SLM with light from a laser; and
projection optics operable to project modulated light from the SLM onto a surface of a workpiece to form an anamorphic reflection of the SLM that is demagnified along the long-axis of the SLM and tightly focused along the short-axis to form a condensed line beam to mark the surface of the workpiece to record an image thereon.

2. The laser marking system of claim 1 wherein the condensed line beam has a sinc² profile along the short-axis with a width of less than ½ of a predetermined minimum feature size, and a length (L) along the long axis of:
$$L = \frac{{E}_{p u l s e}}{{ω}_{s i n c} \cdot {F}_{p e a k}}$$
where Eₚᵤₗₛₑ is a pulse-energy of the laser, ω_{sinc} is a distance from the center of the line beam to a first 0^{th} diffraction order along the short-axis, and Fₚₑₐₖ is a targeted peak fluence of optical energy at the surface of the workpiece.

3. The system of claim 1 further comprising a SLM controller operable to control the SLM, and a computer operable to control the laser and provide image data and trigger signals to the SLM controller.

4. The system of claim 3 wherein the projection optics comprise a number of galvanometric mirrors, and wherein the computer is operable to control at least one of the number of galvanometric mirrors to scan the condensed line beam across a first swath of the surface of the workpiece in a direction perpendicular to a long axis of the condensed line beam to record a two-dimensional (2D) image thereon.

5. The system of claim 4 wherein the computer is operable to control a second one of the number of galvanometric mirrors to move the condensed line beam across the surface of the workpiece in a direction perpendicular to a long axis of the condensed line beam and to scan the condensed line beam across a second swath of the surface parallel to the first swath to record a 2D image larger than a length of the condensed line beam.

6. The system of claim 5 wherein the condensed line beam includes a predetermined minimum feature size formed by modulated light from a plurality of adjacent pixels in the SLM, and wherein the computer is operable to control the number of galvanometric mirrors so that the second swath overlaps the first swath by a number of the plurality of adjacent pixels forming the minimum feature size, and wherein the SLM controller is operable to provide image data to the number of pixels in the second swath overlapping the first swath corresponding to image data provided to the pixels in the first swath.

7. The system of claim 6 wherein the computer is operable to control the number of galvanometric mirrors so that the second swath overlaps the first swath and an edge of the second swath is offset from a corresponding edge of the first swath by a distance less than the minimum feature size.

8. The system of claim 5 wherein the computer is operable to control the number of galvanometric mirrors to move the condensed line beam across the surface of the workpiece so that a boundary between the first and second swaths form an intermeshing sine-wave pattern.

9. The system of claim 3 further including a movable fixture on which the workpiece is positioned, and wherein the computer is operable to control the movable fixture to provide relative motion between the movable fixture and condensed line beam to scan the condensed line beam across a first swath of the surface of the workpiece in a direction perpendicular to a long axis of the condensed line to record a 2D image thereon.

10. The system of claim 9 wherein the movable fixture is further operable to move in a direction perpendicular to a long axis of the condensed line beam, and wherein the computer is operable to control the movable fixture to move the condensed line beam across the surface of the workpiece and to scan the condensed line beam across a second swath of the surface parallel to the first swath to record a 2D image larger than a length of the condensed line beam.

11. The system of claim 10 wherein the condensed line beam includes a predetermined minimum feature size formed by modulated light from a plurality of adjacent pixels in the SLM, and wherein the computer is operable to control the movable fixture so that the second swath overlaps the first swath by a number of the plurality of adjacent pixels forming the minimum feature size, and wherein the SLM controller is operable to provide image data to the number of pixels in the second swath overlapping the first swath corresponding to image data provided to the pixels in the first swath.

12. The system of claim 11 wherein the computer is operable to control the movable fixture so that the second swath overlaps the first swath and an edge of the second swath is offset from a corresponding edge of the first swath by a distance less than the minimum feature size.

13. The system of claim 11 wherein the computer is operable to control the movable fixture to move the condensed line beam across the surface of the workpiece so that a boundary between the first and second swaths form an intermeshing sine-wave pattern.

14. A method for laser marking, the method comprising
generating a light from a laser;
illuminating a spatial light modulator (SLM) comprising a rectangular array of electrically actuated two-dimensional (2D) diffractors arranged to form a plurality of pixels spaced linearly along a long-axis of the SLM, each pixel including a plurality of 2D diffractors electrically ganged together and arranged along a short-axis perpendicular to the long-axis of the SLM;
modulating light incident on the SLM;
projecting modulated light from the SLM onto a surface of a workpiece to form an anamorphic reflection of the SLM that is demagnified along the long-axis of the SLM and tightly focused along the short-axis to form a condensed line beam on the surface of the workpiece; and
scanning the condensed line beam across a first swath of the surface of the workpiece in a direction perpendicular to a long axis of the condensed line beam to record a two-dimensional (2D) image thereon.

15. The method of claim 14 further comprising repositioning the condensed line beam on the surface of the workpiece in a direction perpendicular to a long axis of the condensed line beam and scanning the condensed line beam across a second swath of the surface parallel to the first swath to record a 2D image larger than a length of the condensed line beam.

16. The method of claim 15 wherein the condensed line beam comprises a minimum feature size formed by modulated light from a plurality of adjacent pixels in the SLM, and wherein moving the condensed line beam perpendicular to the long axis of the condensed line beam and scanning the condensed line beam across the second swath comprises overlapping the first swath by a number of the plurality of adjacent pixels forming the minimum feature size, and providing image data to the number of pixels in the second swath overlapping the first swath corresponding to image data provided to the pixels in the first swath.

17. The method of claim 16 wherein scanning the second swath comprises overlapping the first swath such than an edge of the second swath is offset from a corresponding edge of the first swath by a distance less than the minimum feature size.

18. The method of claim 15 wherein scanning the first swath and the second swath comprise simultaneously moving the condensed line beam across the surface of the workpiece so that a boundary between the first swath and second swath form an intermeshing sine-wave pattern.

19. A laser manufacturing system comprising:
a spatial light modulator (SLM) including a rectangular array of electrically actuated two-dimensional (2D) diffractors arranged to form a plurality of pixels spaced linearly along a long-axis of the SLM, each pixel including a plurality of 2D diffractors electrically ganged together and arranged along a short-axis perpendicular to the long-axis of the SLM;
illumination optics operable to illuminate the SLM with light from a laser; and
projection optics operable to project modulated light from the SLM onto a work surface to form an anamorphic image of the SLM that is demagnified along the long-axis of the SLM and tightly focused along the short-axis to form a condensed line beam to modify a material at the work surface.

20. The system of claim 19, wherein the manufacturing system is an additive manufacturing system, the work surface comprises a surface of a photosensitive resin in a vat into which a fixture is incrementally lowered to add layers of material to a workpiece formed thereon as the modulated light from the SLM reacts with the photosensitive resin at the surface of the vat.
